(19) United States
(12) Patent Application Publication
(10) Pub. No.: US 2002/0002497 A1
(43) Pub. Date: Jan. 3, 2002

(54) Method and system of marketing and selecting color

(76) Inventor: Steve Tilman, Raleigh, NC (US)

Correspondence Address: Alana G. Kriegsman, Kilpatrick Stockton LLP, 1001 West Fourth Street, Winston-Salem, NC, 27101, US

(21) Appl. No.: 09/811,348

(22) Filed: Mar. 16, 2001

Related U.S. Application Data
(60) Provisional application No. 60/189,778, filed on Mar. 16, 2000.

(51) Int. Cl. G06F 17/60

(52) U.S. Cl. 705/26

(57) ABSTRACT

The present invention provides a method and system of marketing and selecting color. The method and system incorporate factors relating to the effect of color in users' lives. As used herein the term “user” includes, but is not limited to, consumers, sales/marketing personnel, designers, manufacturers, and painters.

### PRIORITY APPLICATION

This application claims the benefit of U.S. Provisional Application No. 60/189,778 filed Mar. 16, 2000 and entitled “Method and System of Marketing and Selecting Color,” which is incorporated herein by reference.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BRIEF DESCRIPTION OF THE DRAWINGS

The above object and advantages of the present invention will become more apparent by describing in detail a preferred embodiment thereof with reference to the attached drawings in which:

FIG. 1 depicts a user preference comprising activity level.

FIG. 2 depicts a user preference comprising typical room occupancy.

FIG. 3 depicts a user preference comprising available light.

FIG. 4 depicts a user preference comprising room exposure.

FIG. 5 depicts a user preference comprising desired spatial effect.

FIG. 6 depicts a questionnaire which may be presented to a user to determine user preferences.

FIG. 7 (consisting of pages 7A, 7B and 7C) presents an Example “Hue and Light Grid” (HLG) wherein the y-axis represents “light reflective value” (LRV), and the x-axis represents hues, in spectrum order.

FIG. 8 (consisting of pages 8A, 8B, 8C, 8D, 8E, 8F, 8G, 8H, 81, 8J, 8K, 8L and 8M) depicts names associated with the colors contained on the Example HLG of FIG. 7.

FIG. 9 presents a summary of the flow of the basic logic of an embodiment of the system and method of the present invention.

FIG. 10 (consisting of pages 10A, 10B, 10C, 10D, 10E, 10F, 10G, 10H, 10I, 10J, 10K, 10L, 10M, 10N, 10O, 10P, 10Q, and 10R) presents source code enabling a preferred embodiment. FIGS. 10H, 10K, 10N, 10O, 10P, 10Q and 10R depict displays of a user interface.

### BACKGROUND OF THE INVENTION

The present invention relates to a method and system of marketing and selecting color incorporating factors relating to the effect of color in users' lives. As used herein the term “user” includes, but is not limited to, consumers, sales/marketing personnel, designers, manufacturers, and painters.

The effect of color in user(s)' lives is profound. It plays a critical role in setting the mood for any environment, evoking in user(s) subtle yet strong emotional responses, and conveying messages ranging from exciting and pleasurable to quiet and somber.

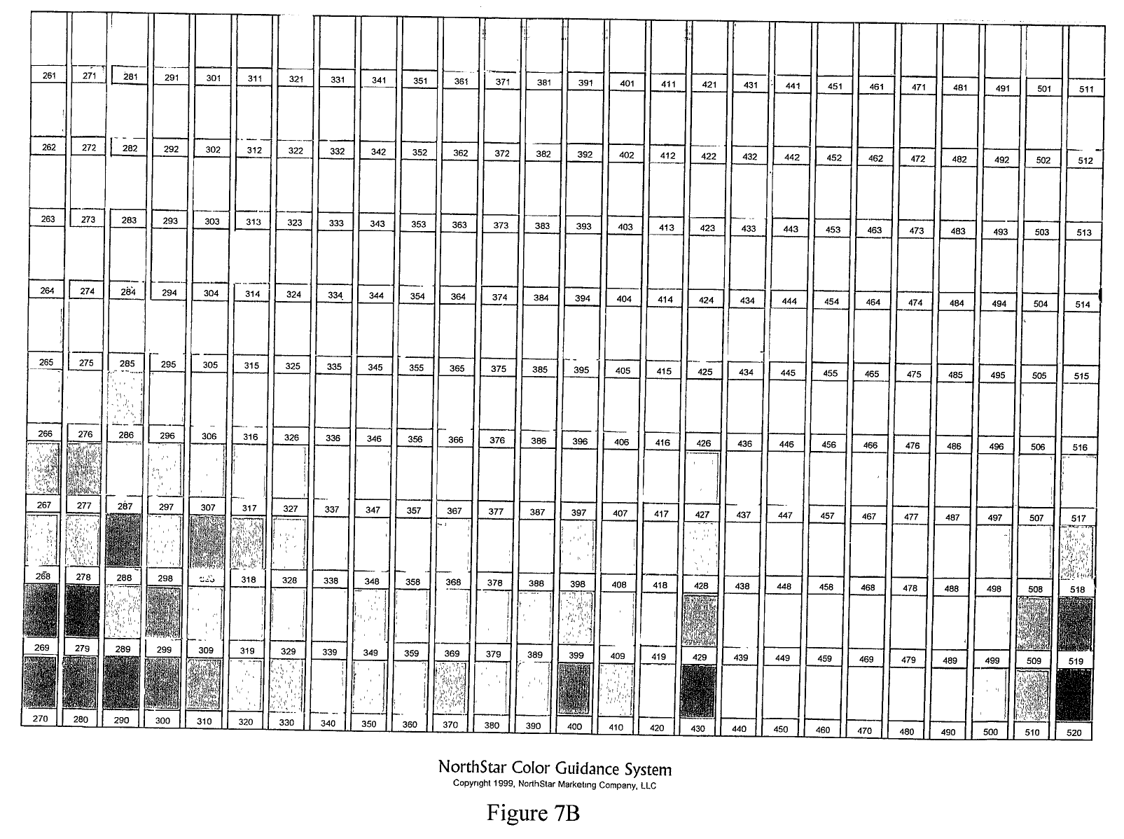

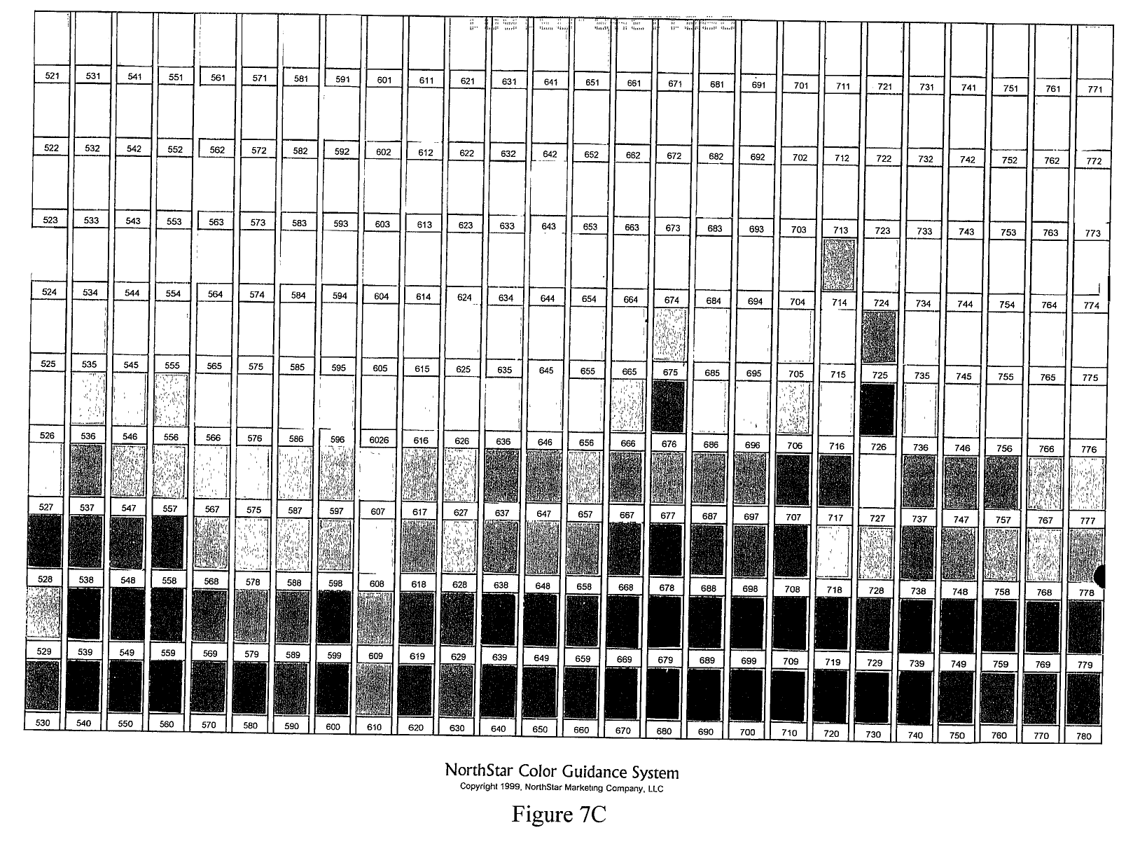

The method and system of the present fulfills a hereto unmet need in alleviating user(s) bewilderment in color selection by providing a simple, systematic method of reviewing a large number of colors (for example, over 750 colors can be reviewed, see FIG. 7), and narrowing options to a minimal number of target colors. The method and system of the present invention is equally applicable to paint, wallpaper, flooring, accessories, window treatments and the like.

### SUMMARY OF THE INVENTION

Each color has two attributes that function independently of their interaction with other colors——brightness as expressed by its “light reflective value” (LRV); and second, intrinsic warmth or coolness. Light reflective value may be affected both by saturation and/or the amount of tinting or shading added to the base color, but a color's LRV ultimately takes into consideration both of those variables. Colors also may appear warmer or cooler depending on their position and size relative to other colors; however, they are considered to have intrinsic “temperatures” independent of other colors; viz., blues are considered cool, yellows, medium to warm, and reds, the warmest. Thus, depending on which direction one moves on the spectrum, either towards blue or towards red, a sense of coolness or warmth is being added to the decorating scheme. Therefore, these two “basic attributes,” LRV and intrinsic temperature, provide the two variables that can be manipulated by other factors.

The system and method of the present invention is based on this concept. The system and method of the present invention comprises a “Hue and Light Grid” (HLG) created with LRV forming the y-axis and hues, in spectrum order, forming the x-axis.

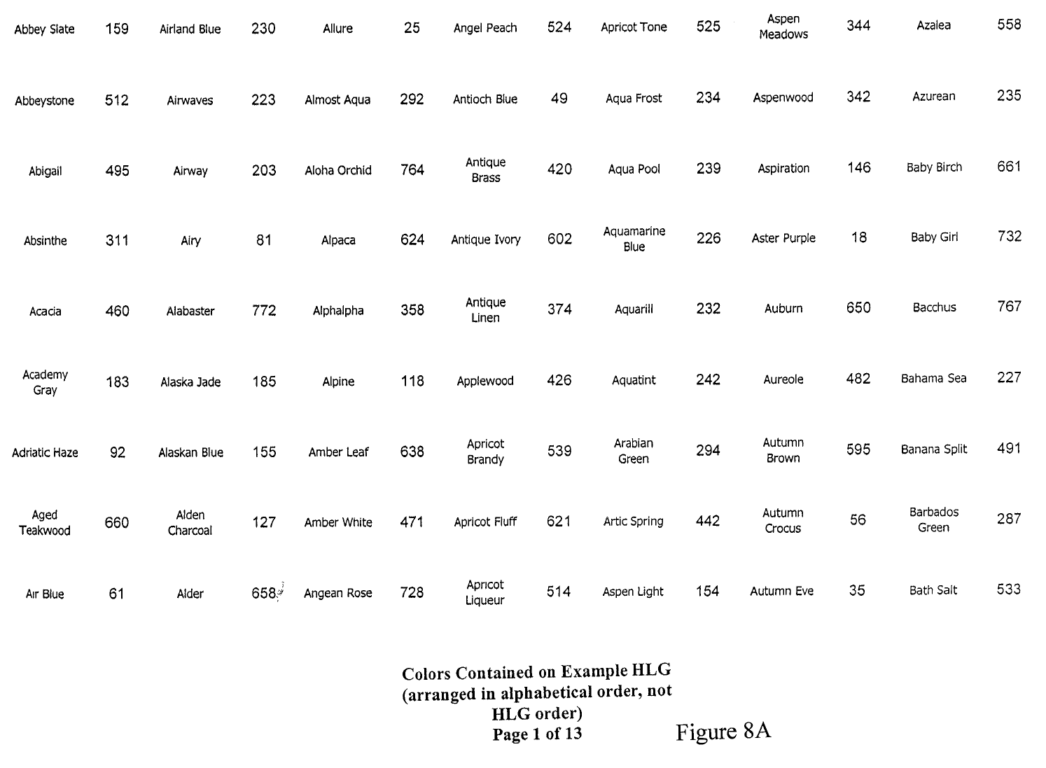

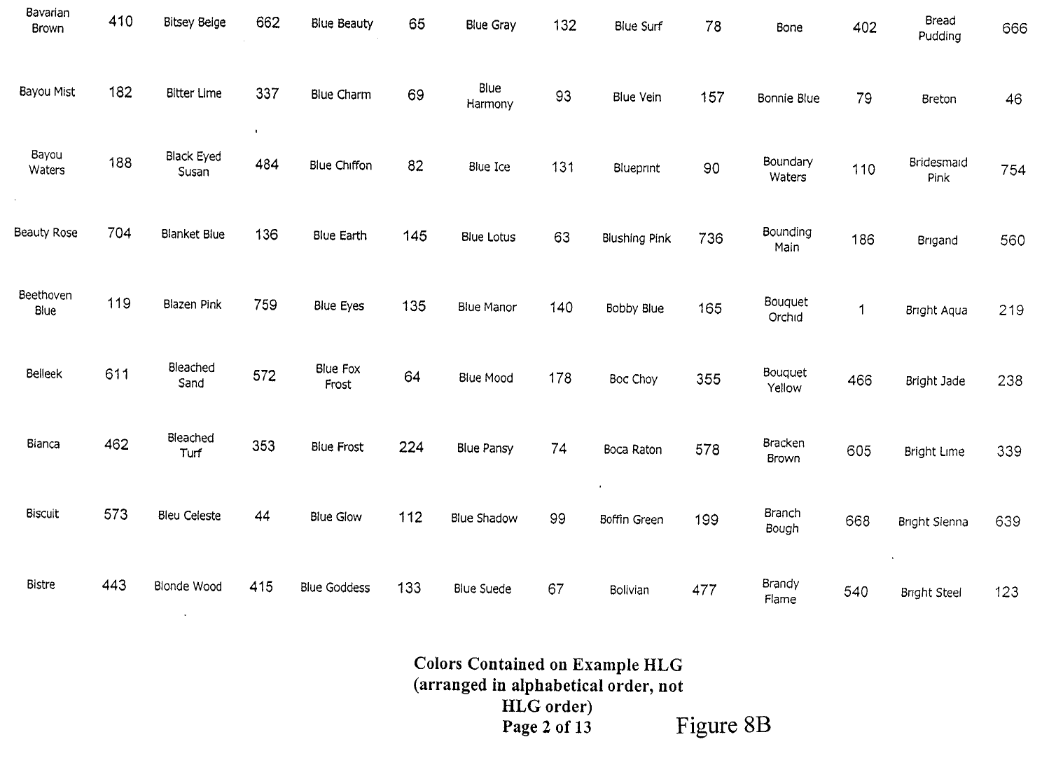

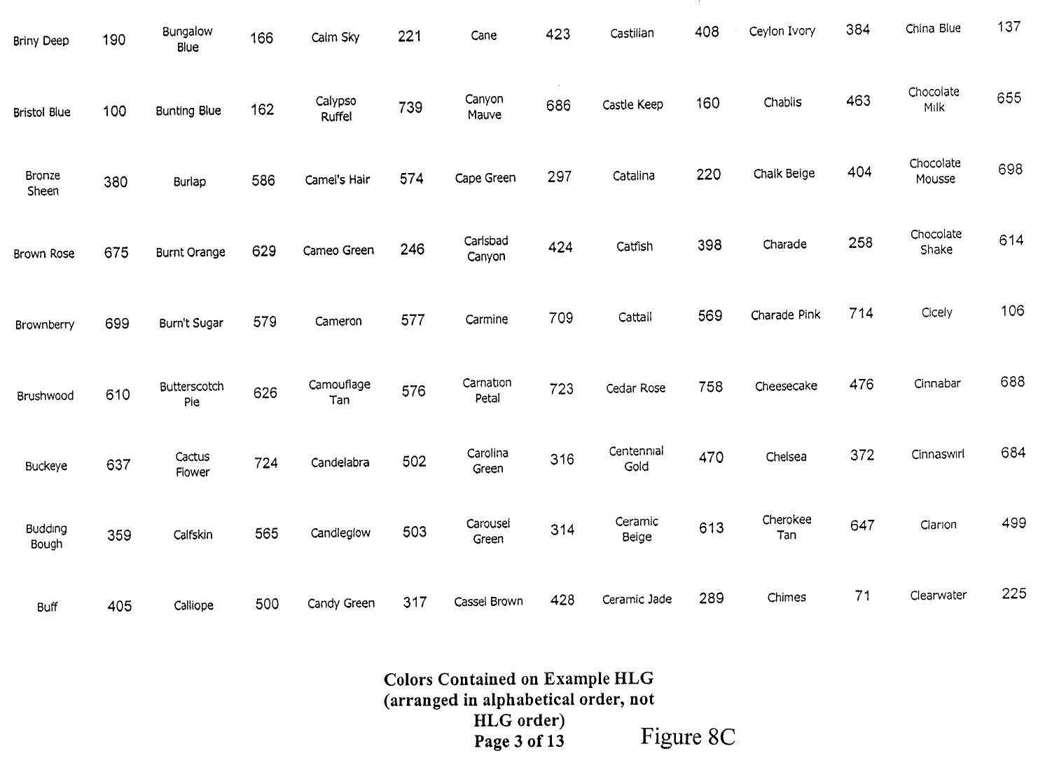

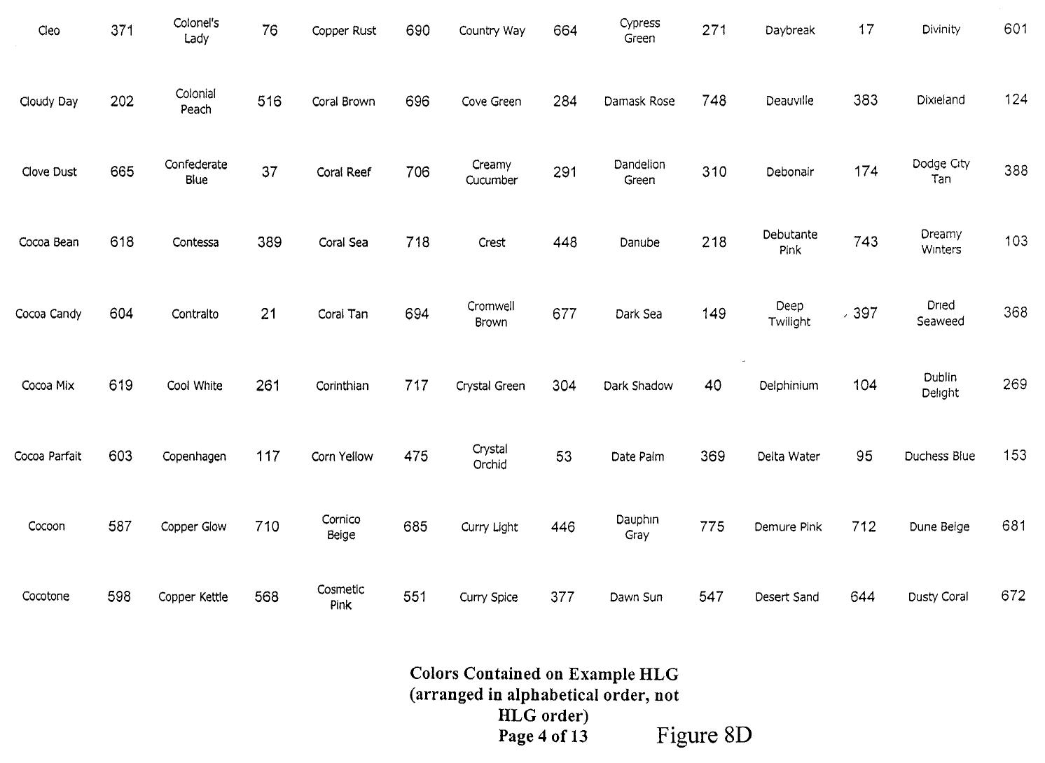

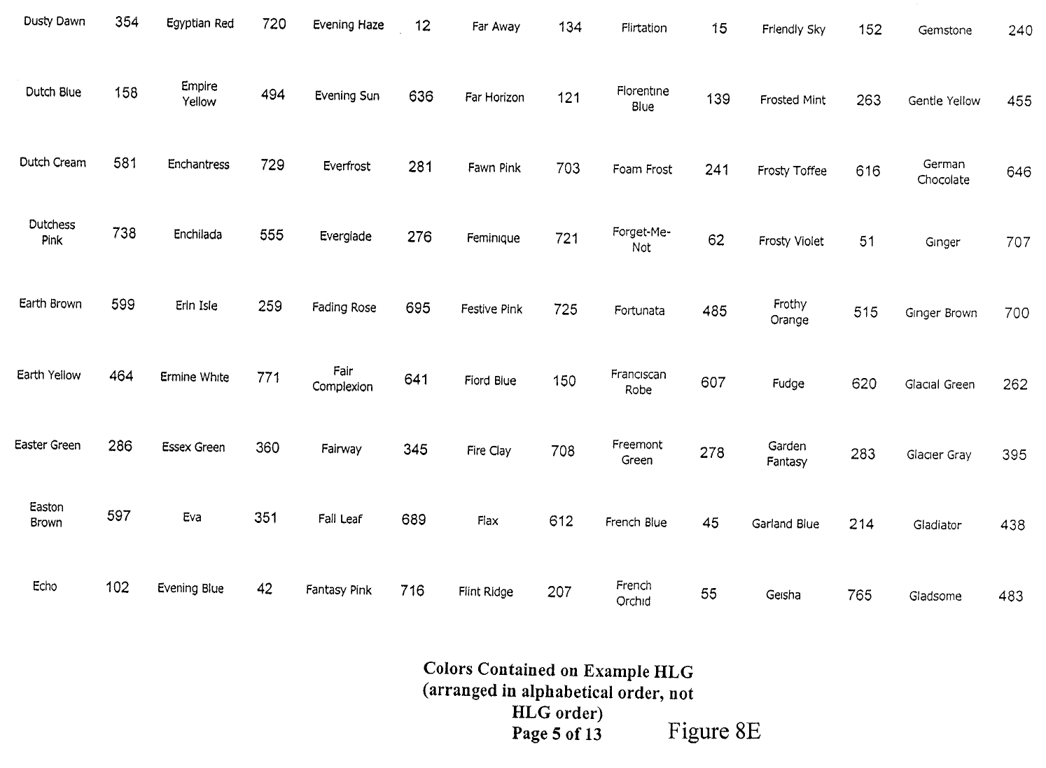

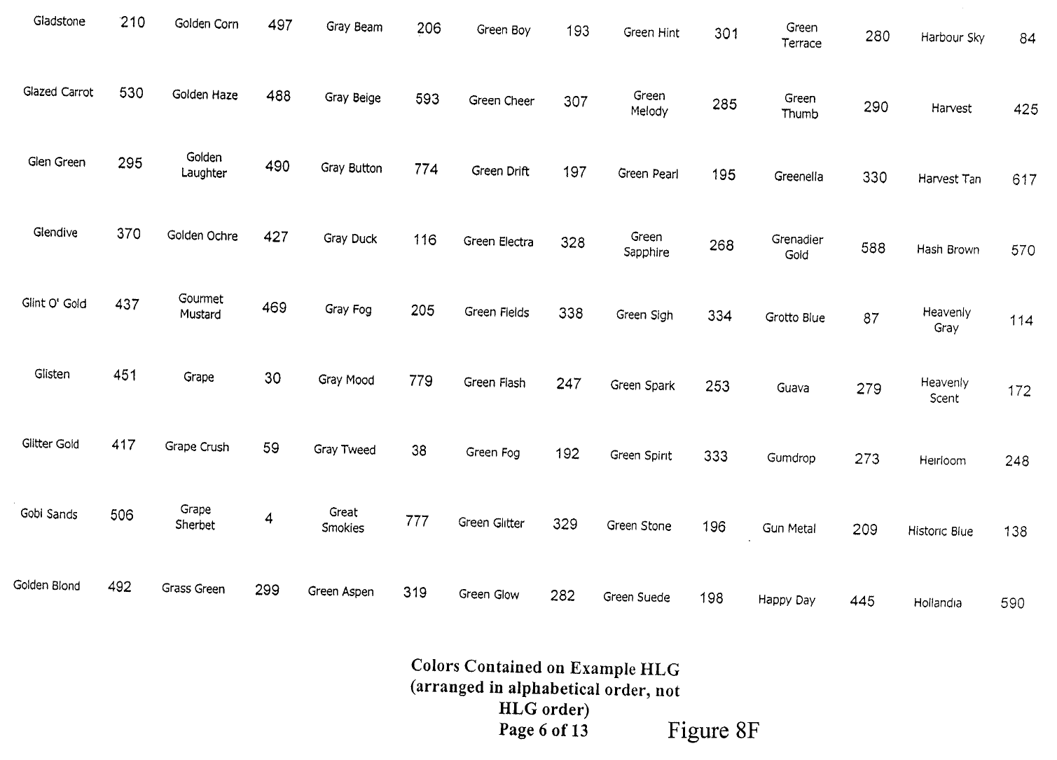

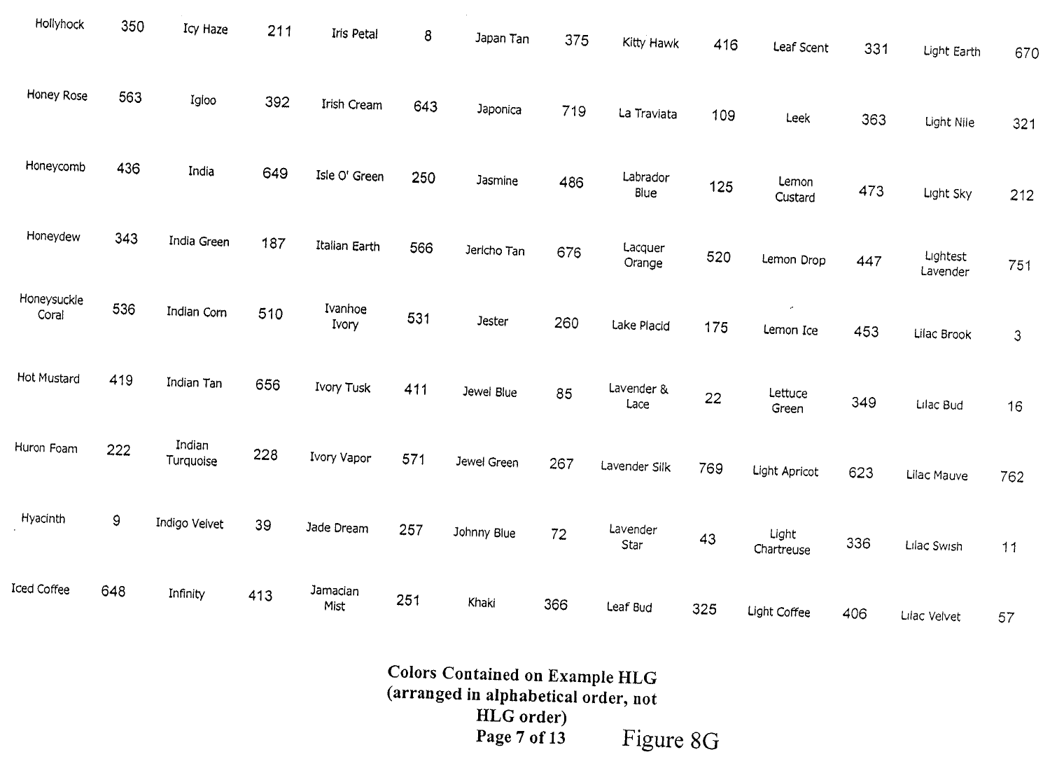

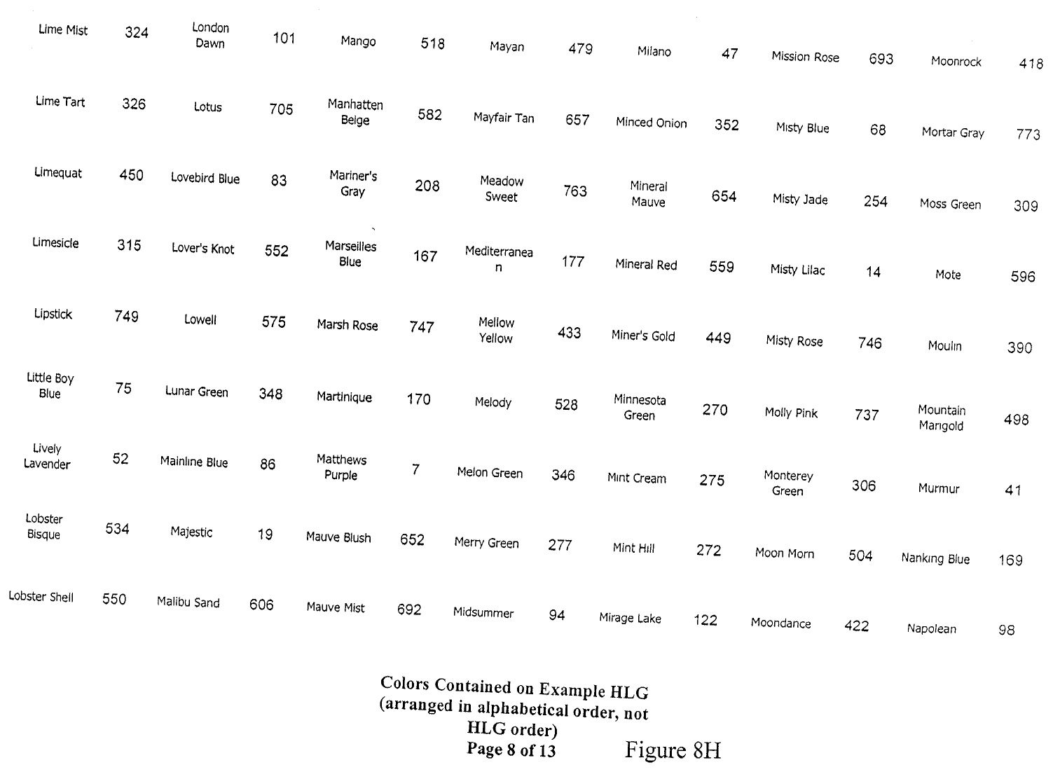

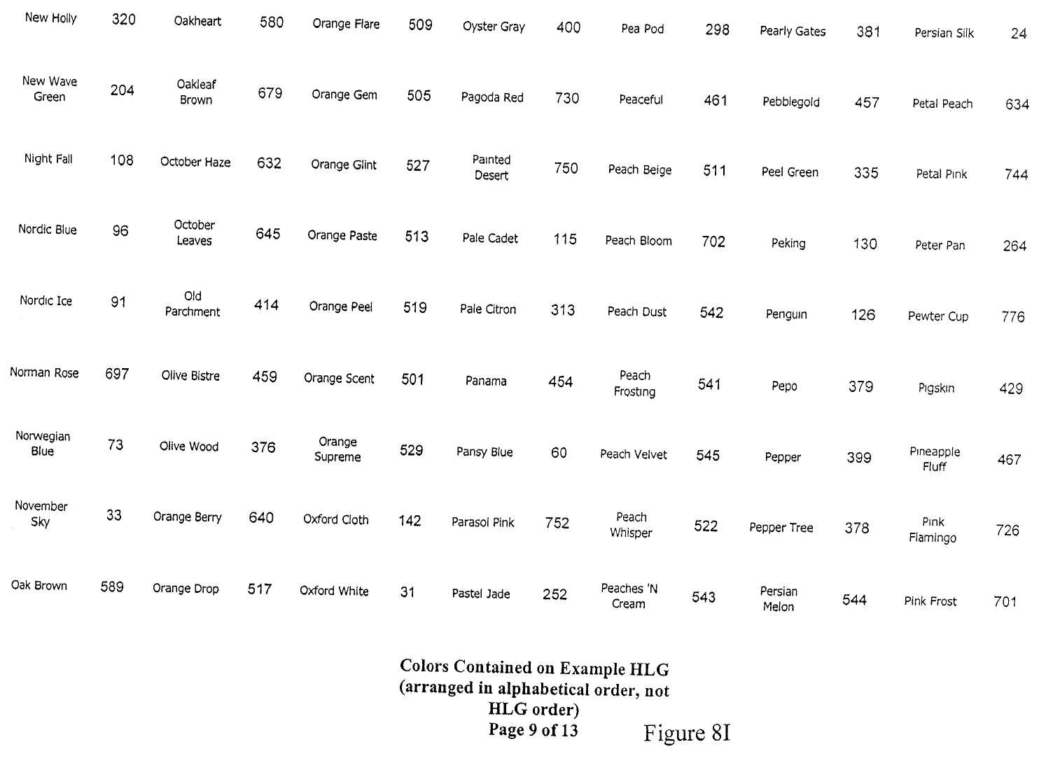

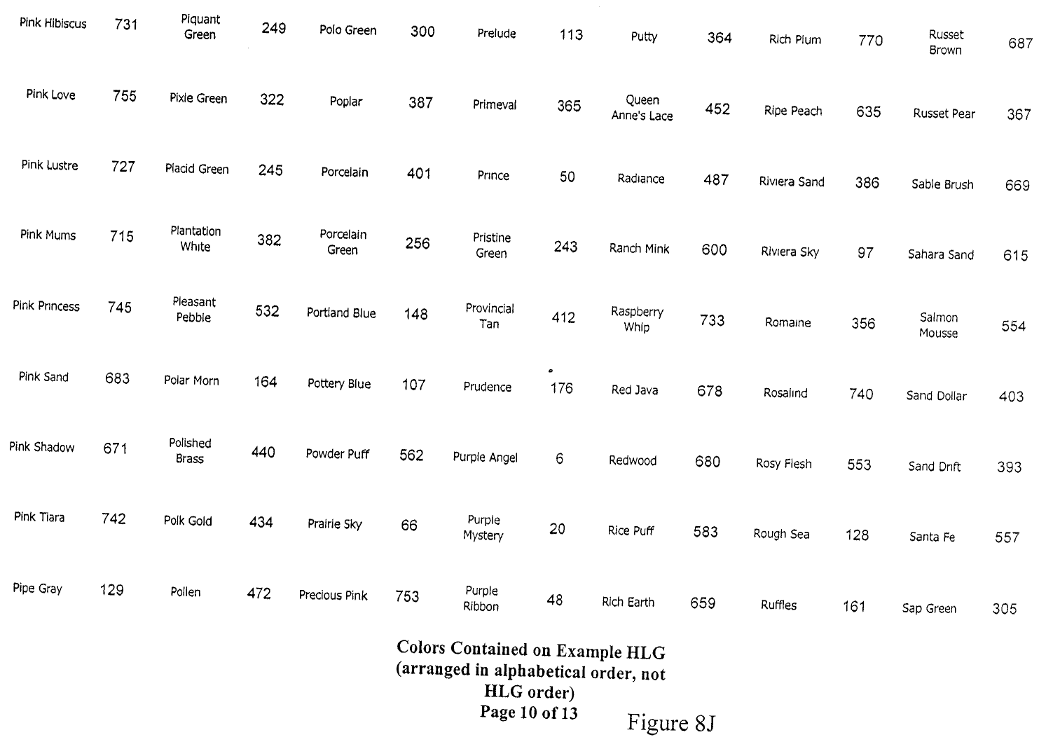

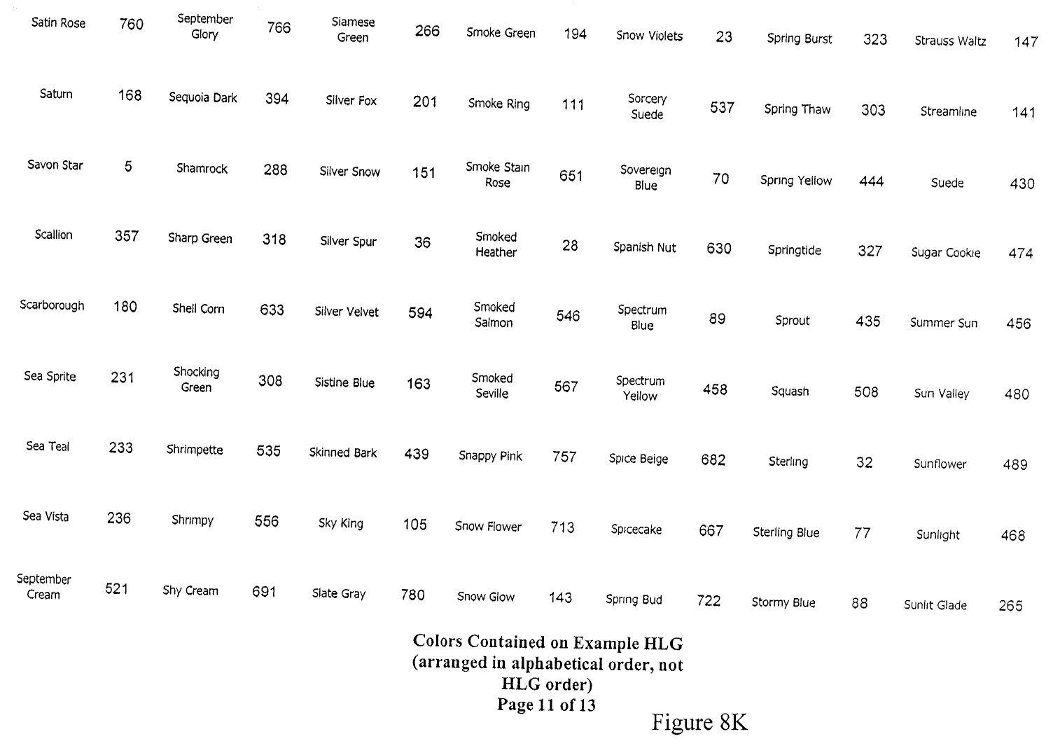

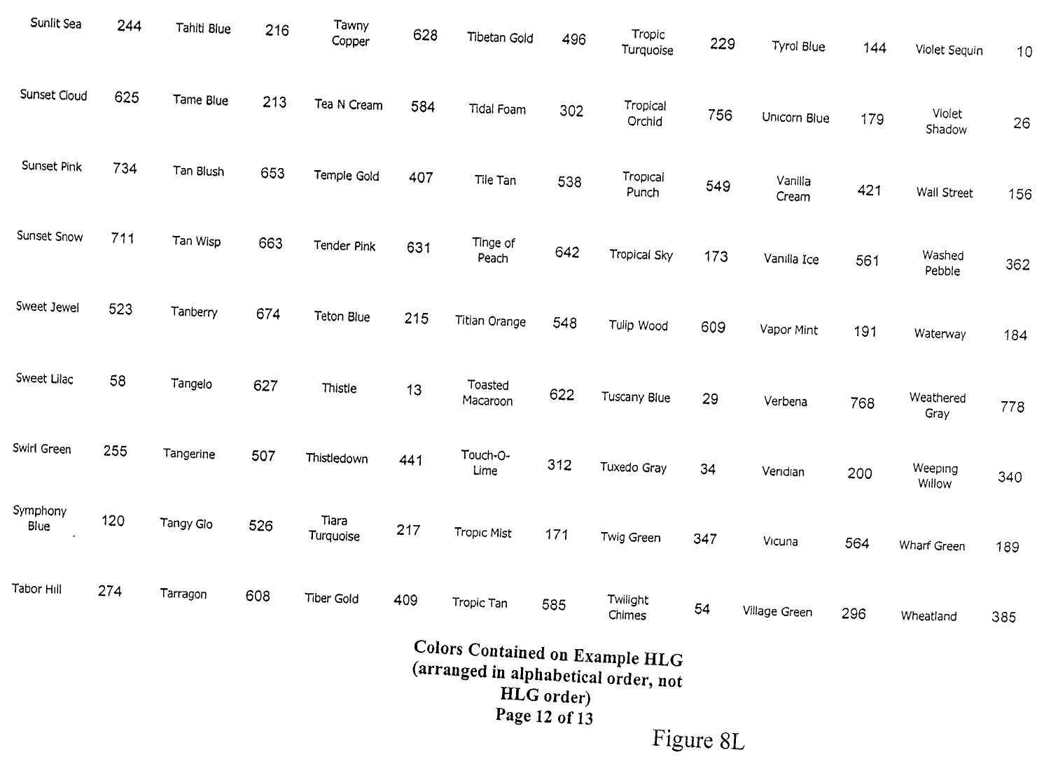

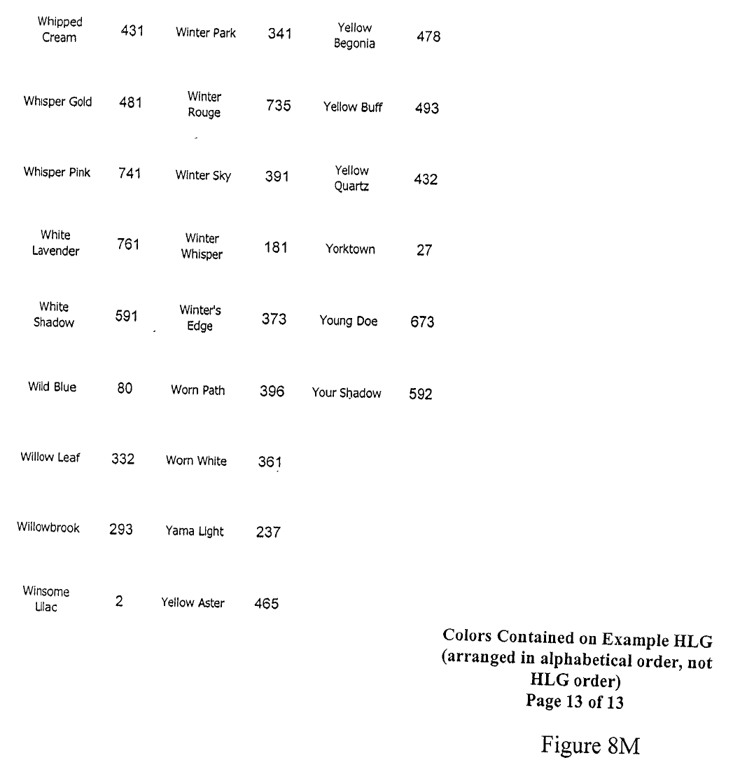

See FIGS. 7 and 8. In an embodiment of the present invention, using the HLG, the system and method of the present invention allows a user(s) (user(s), defined hereafter) to apply sound design principles to the selection of color, and provides designer(s) with a method for enhancing communication with client(s) and thereby improving the overall design of a space.

The first step in an embodiment of the system and method of the present invention is to select a range of colors that takes into consideration the user's learned emotional preferences to basic colors. For example, there would be no point suggesting a color scheme that uses yellow as the predominant color when the user, for whatever reason, has developed a strong negative reaction to yellow. Instead, the colors are arranged in three “basic color families” that include a primary color and two secondary colors. The user first selects his or her favorite basic color family. (For the purposes of this description, it is assumed that the user wants to consider the full range of color options available in the Basic Color Family, “Blue, Blue Violet, Blue Green.”) From this point forward, only the corresponding portion of the HLG will be used. Basic Color family & Sub-family Options are presented below:

Blue, Blue Violets, Blue Greens Blue only

Blue-Violet only Blue Green only

Yellow, Yellow Greens, Yellow Oranges Yellow only

Yellow Green only

Yellow Orange only

Red, Red Oranges, Red Violets Red only

Red Orange only Red Violet only

In the second and third steps of said embodiment, a room's functionality is used to target more specifically preferred color choices within the selected Basic Color family or Sub-family. Functionality of a room is measured on two scales: (1) activity level, and (2) number of persons using the room. It is generally accepted that cooler, darker colors tend to enhance solitude, while warmer, lighter colors tend to enhance group functions. It is also generally accepted that cooler, darker colors tend to reinforce lower levels of activity, while warm, bright colors tend to enhance higher levels of activity. A grid can be used to measure these two factors. On a scale of 1 to 10 (with 10 being the most active and 1 being the least active) a user is asked to describe the level of energy expended for activities typically occurring in the room. Then, on a scale of 1 to 10 (with 10 being a large number of people and 1 being the least number of people) a user is asked to rank how many persons will typically use the room.

A room is ranked 4 for moderate to low activity. It is ranked 7 for a higher number of people using the room. This ranking could, for example, reflect the room's use as a frequent gathering place for a group of friends who enjoyed relaxed conversation. A bedroom, by contrast, might rank low on the number of people using it and low on activity as well (or not).

The numbers on the Brightness Scale and the Warmth Scale correspond to a range of colors within the Basic Color family. Specifically, on the Brightness Scale, each of the ten increments corresponds to two rows on the HLG. On the Warmth Scale each of the ten increments corresponds to two columns on the HLG. Once the optimal rows and columns on the HLG are determined, then the adjacent four rows and four columns on each of the four sides of the optimal targeted row and column will be included in the new target area. This forms the optimal target area for color selection.

In step four of said embodiment, the effect of a room's available light on color choice is considered. In this process the available natural light in a room is estimated from “no natural light available” (for example, represented by a 5 on the scale) to “high amount of natural light” (for example, represented by 1 on the scale); thus, for example, if a room scores a 3, then the optimal color area is limited to the third through eighth rows of the targeted area on the HLG. If a room scores a 2 or lower, for example, then the optimal color area is limited to the first through fourth rows of the targeted area on the HLG. Alternatively, for example, if a room scores a 4 or higher, then the optimal color area is limited to the seventh through tenth rows of the targeted area on the HLG.

In step five of said embodiment, the effect of a room's exposure on color selection is considered. The subject room is measured for exposure with 1 representing, for example, both a true southern or western exposure, and 5, for example, representing a true northern or eastern exposure; thus, for example, if a room scores 2 or lower then the optimal color area is limited to colors in the first through fourth columns of the targeted area on the HLG. if a room scores 3, for example, then the optimal color area is limited to colors in the third through eighth columns of the targeted area on the HLG, and f a room scores 4 or higher then optimal color area is limited to colors in the seventh through eighth columns of the targeted area on the HLG.

Note that the optimal number of target colors has now been reduced to 16. A reduction to a final 4 suggested colors can be made by considering the effect of color on the desired spatial perception of the subject room. The user first selects between a room that is perceived overall as larger or smaller. The user then selects between a room that is perceived overall as more open or more closed. These two choices move the targeted area to one of four quadrants. The four quadrants are based on the design principle that bright and cool colors tend to make a room feel more open, while darker, warmer colors tend to make a room feel more cozy and intimate. The color selection has now been winnowed to 4 final suggested colors. In this final step, the user should take into consideration other factors such as the type of furnishings used in the room. For instance, a bright and open color selection may work well as a visual counterpoint to existing massive furniture, rich rugs, and weighty accessories.

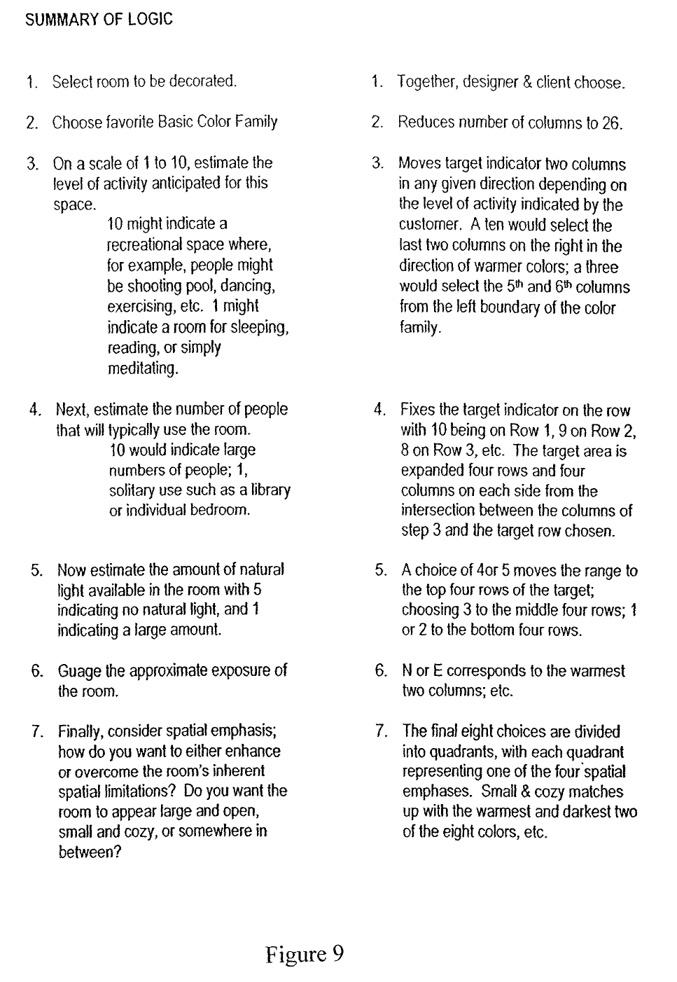

Note that in this last step, the selection of color schemes may be taken into consideration, with each of the final two colors simply providing the base color for the decorating scheme. Because the color is considered the base color does not necessarily mean that color will be used as the predominant color on all painted surface areas. In fact, it may occupy second or third place in total area covered; however, it is the dominant color around which the scheme is built. FIG. 9 presents a chart summarizing the method and system of the present invention.

### DESCRIPTION OF THE INVENTION

The present invention provides a method and system of marketing and selecting color. The method and system incorporate factors relating to the effect of color in users' lives. As used herein the term “user” includes, but is not limited to, consumers, sales/marketing personnel, designers, manufacturers, and painters.

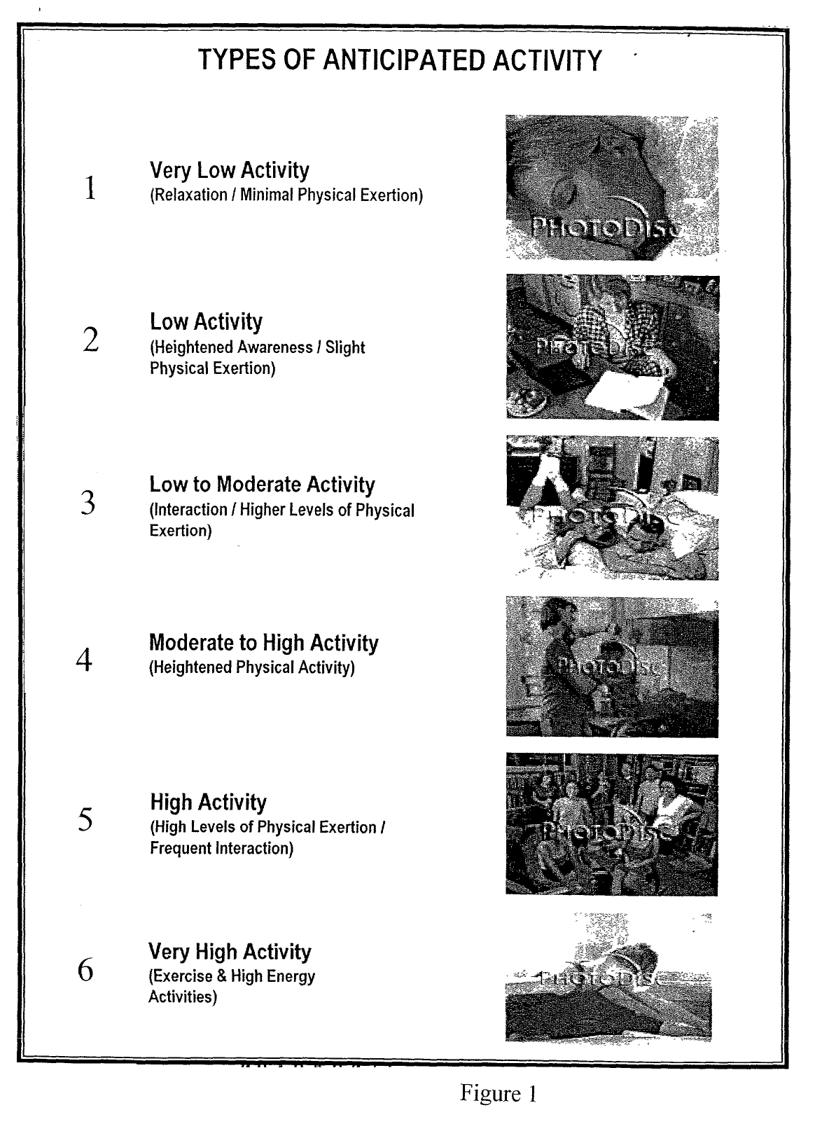

It is an object of the present method and system to provide a method and system by which a user's preferences guide the selection of a color appropriate for use or inclusion in a particular location, such as for example paint color selected for and applied to a residential living room. User's preferences may include one or more of the following factors associated with a location: activity level, typical room occupancy (including functionality, area traffic), selection of primary and/or secondary colors, exposure, amount of light, furniture, and patterns of wallpaper, or other color sources already present in the location. See FIGS. 1-5.

It is a further object of the present method and system to provide a method and system which incorporate traditional interior design and color theory principles. Said principles include factors relating to the role of color in setting the mood for an environment, evoking emotional responses, and conveying messages ranging from excitement and pleasure to quiet and somber.

For instance, activity levels are affected by color choices. Warmer, brighter colors tend to enhance activity levels, while cooler, darker colors tend to moderate activity levels. In a preferred embodiment, the present invention presents examples of different activities (see FIG. 1) and allows a users to select the level that bests suits the activity most common to the room/area to be associated with the color(s) to be selected.

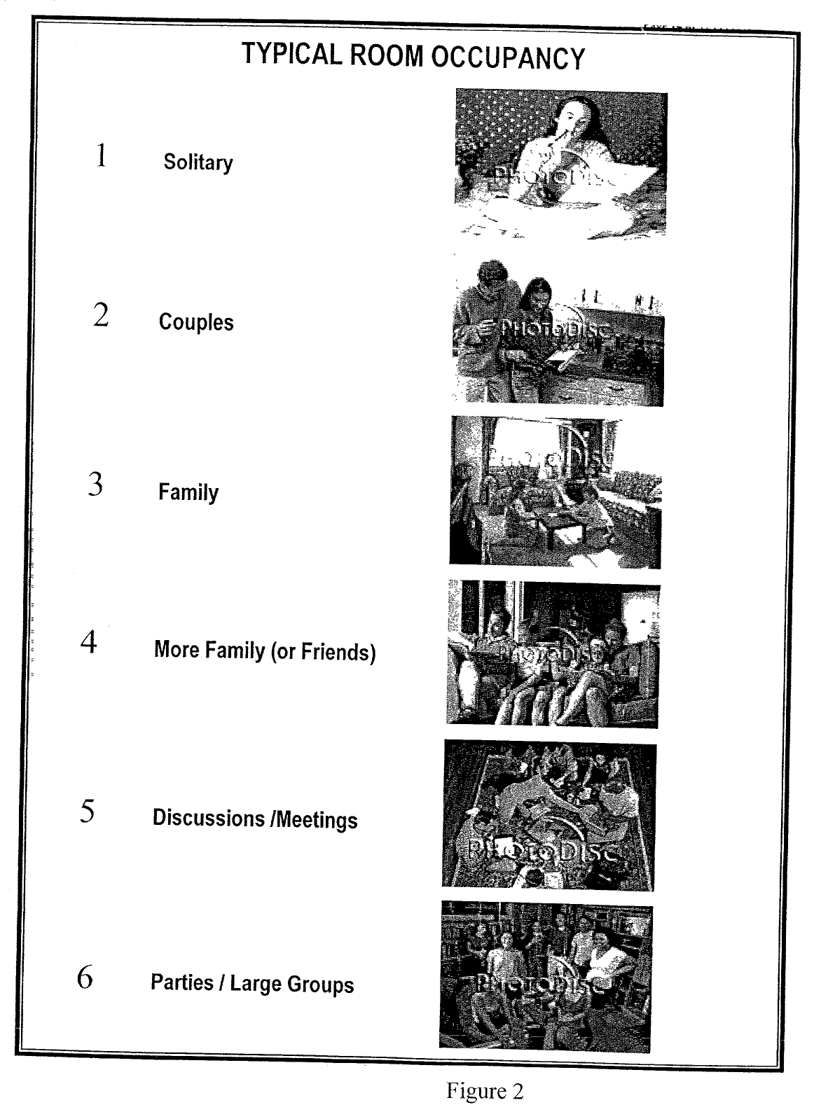

Just as activity levels are affected by color changes, so also do levels of personal interaction fluctuate with shifts in hues or reflective values of colors. Warmer, brighter colors tend to accompany increased interactions while cooler, darker colors tend to correlate with reduced personal interaction. In a preferred embodiment, the present invention presents examples of different typical room occupancies (see FIG. 2) and allows a users to select the occupancy level that bests suits the occupancy most common to the room/area to be associated with the color(s) to be selected. In a preferred embodiment, the levels depicted may present, an indicator of the relative number of people, as opposed to present the exact number of people using a room.

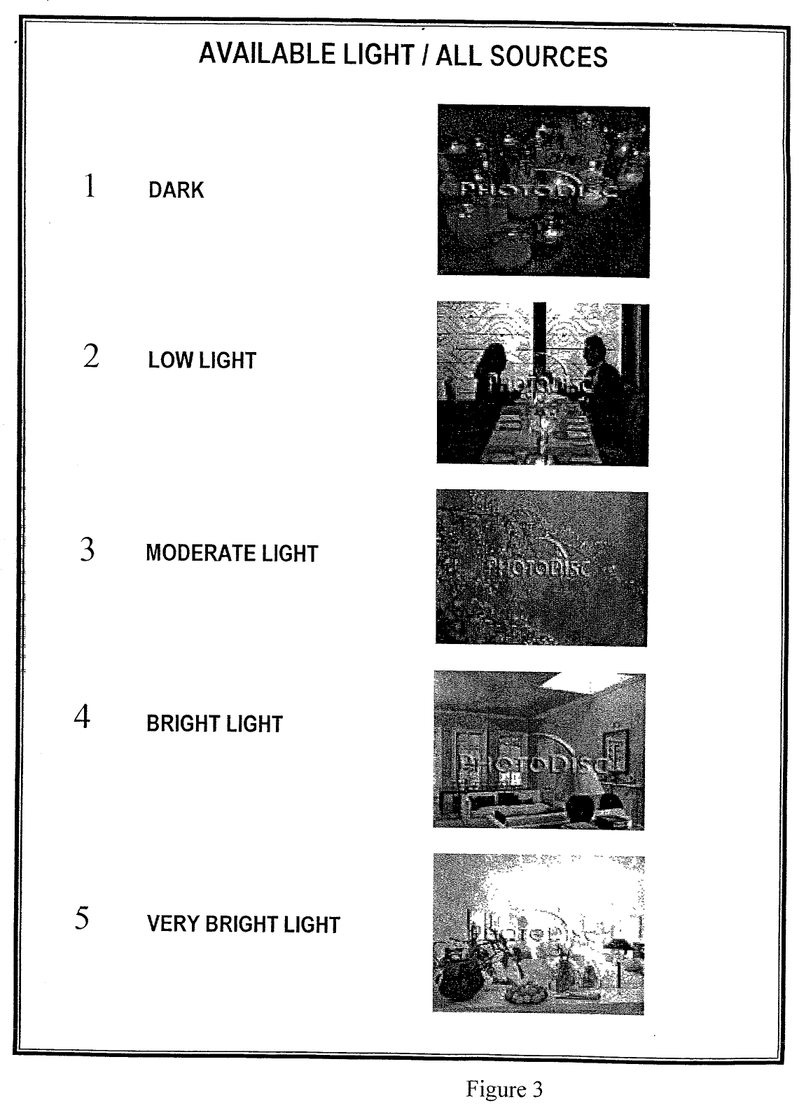

In general, the brighter a room, the darker the colors that can be used effectively. A very bright room (especially if its light source is natural) offers a great opportunity to use a broad range of colors. In a preferred embodiment, the present invention presents examples of available light levels (see FIG. 3) and allows a users to select the level that bests suits the light level most common to the room/area to be associated with the color(s) to be selected. In a preferred embodiment, the levels depicted may include consideration of the light level that most often fills the room, and/or include consideration of the time of day the room is most often used as this affects available light.

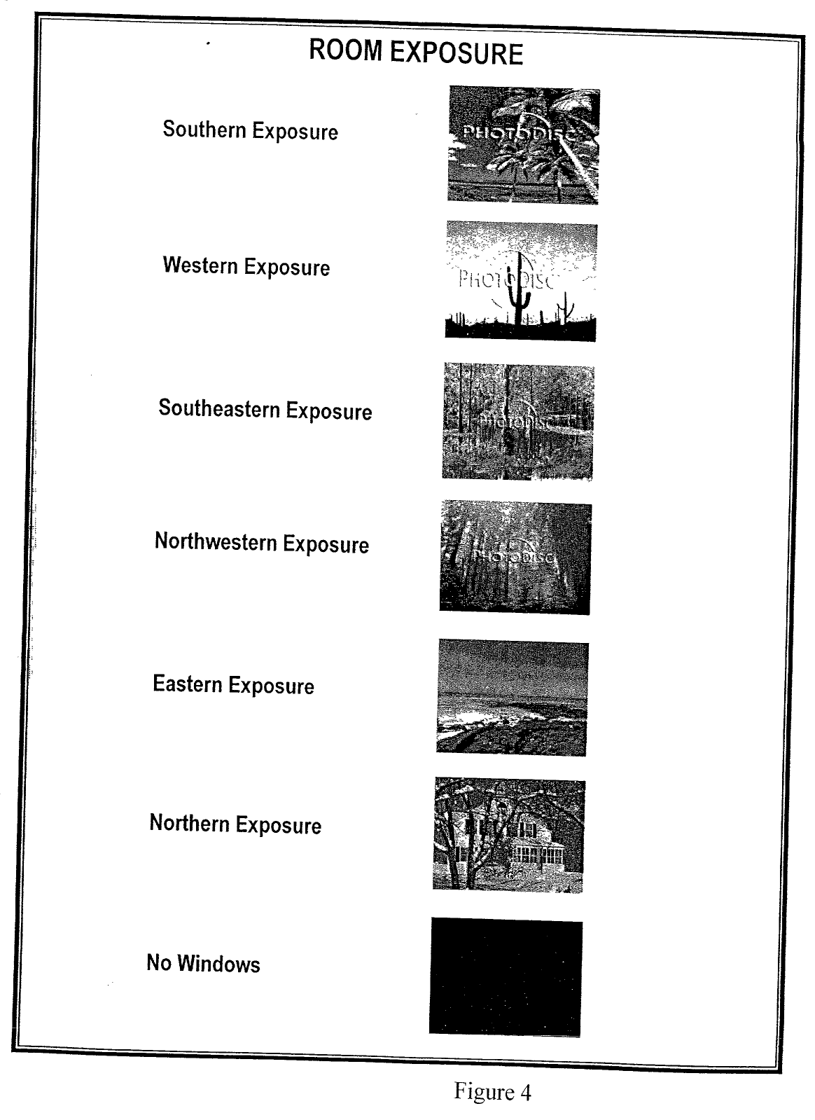

Room exposure also affects color. Southern or western facing rooms generally require cooler colors, while rooms with northern or eastern exposure generally need warmer colors. In a preferred embodiment, the present invention presents examples of room exposure (see FIG. 4) and allows a user to select the exposure that most closely fits the exterior exposure of the room/area to be associated with the color(s) to be selected.

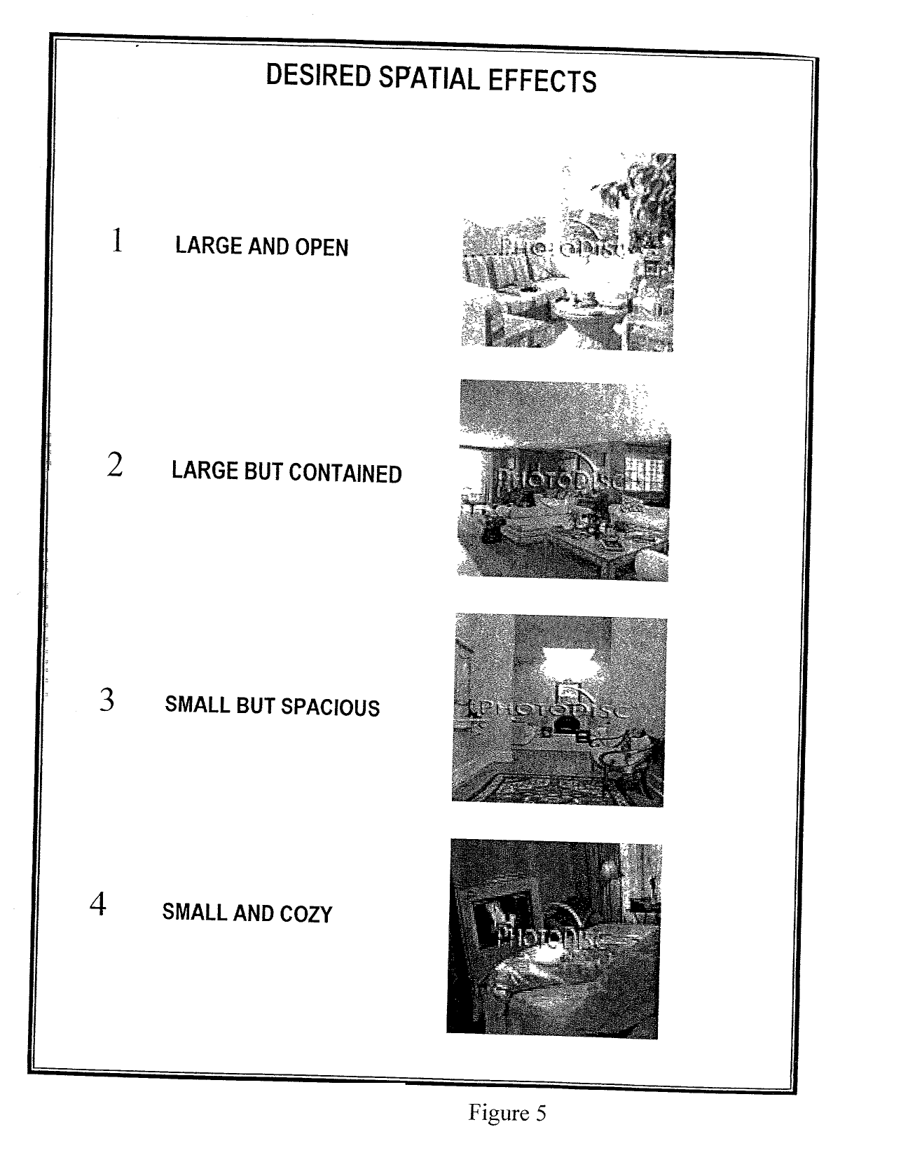

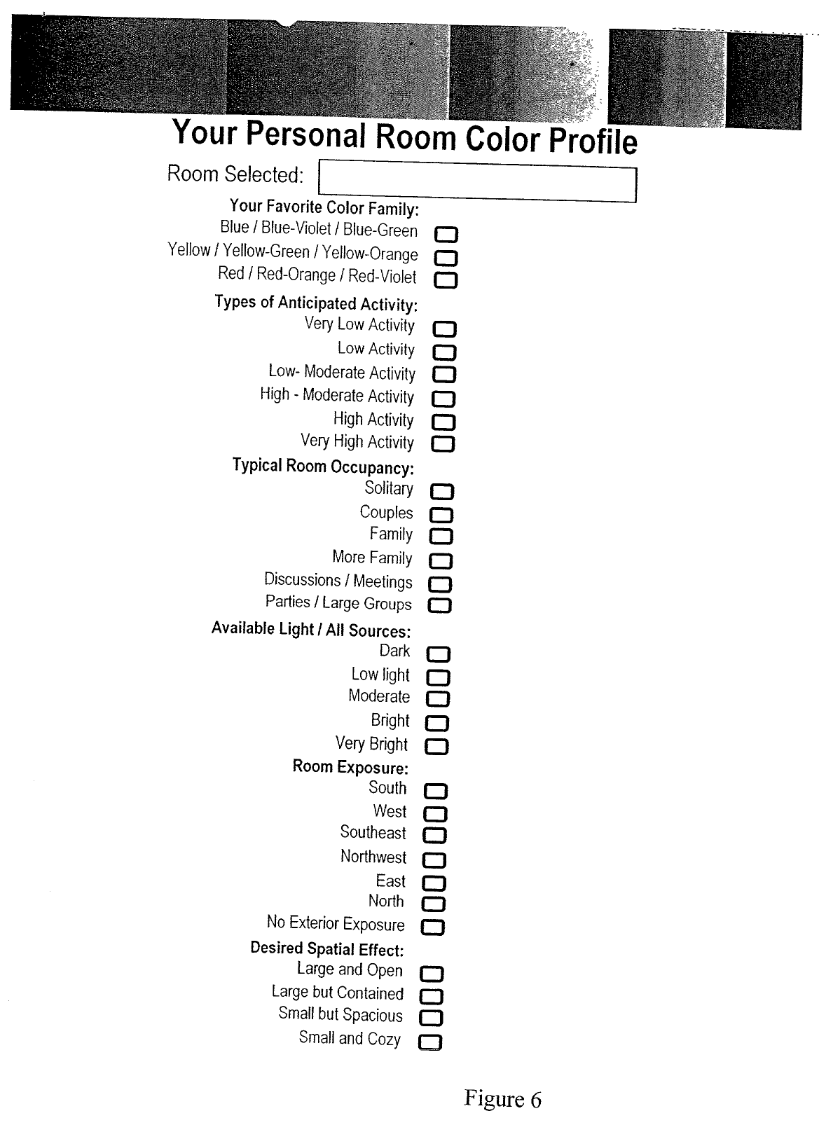

Color affects the overall perception of space in a room. Warm, dark colors cause a room to feel smaller and cozier than cool, light colors. Conversely, cool and light colors tend to cause a room to feel larger and more open. A user, however, may wish to keep the sense of largeness without throwing open the room to the world, or alternatively, a user may want to take a small room and make it feel as spacious as possible. In a preferred embodiment, the present invention presents examples of desired spatial effects (see FIG. 5) and allows a user to select the spatial effect that most closely depicts the spatial effect desired to be achieved in the room/area to be associated with the color(s) to be selected.

In an alternative preferred embodiment of the present invention a questionnaire (for example, but not limited to, that presented in FIG. 6) may be used to determine user preferences.

It is a further object of the present method and system to provide a straight-forward, systematic method of reviewing over 750 colors and narrowing the range of possible colors appropriate for a particular location to a predetermined number of target colors. (See FIGS. 7 and 8.)

It is a further object of the present method and system to allow users to easily create stunning color combinations that capture a desired mood or ambiance for a particular residential, commercial, or industrial location. The method and system of the present invention can be applied to the selection of paint, wallpaper, flooring, accessories, window treatments, furniture, and/or other colored objects.

It is a further object of the present method and system to provide a means by which a user can market services related to the selection and application of color, said method and system optionally including guiding a consumer in the selection of a range of possible colors appropriate for a particular location, immediate testing of one or more of said colors, and immediate provision of an executable contract containing costs and terms associated with the application of one or more of said colors to said location.

FIGS. 7 presents an Example “Hue and Light Grid” (HLG) wherein the y-axis represents “light reflective value” (LRV), and the x-axis represents hues, in spectrum order.

In a preferred embodiment, the present invention comprises a method of selecting one or more colors, said method comprising a “hue and light grid” (HLG) (see FIG. 7) comprising a plurality of colors, wherein said HLG is divided into “basic color families” (BCF), each BCF including at least one primary color, and wherein each vertical row of said HLG is a “basic color family row” (BCFR), and said method comprising the following steps: (1) selecting a location to be colored; (2) selecting a range of colors from said HLG, said range of colors corresponding with one or more user preferences to basic colors and said range of colors being a BCF; (3) associating a functionality value with said location; (4) using said functionality value to target a first set of selected rows and selected columns, said first set of selected rows and selected columns being within said BCF which corresponds with said range of colors selected in step (2); (5) associating an “amount of light” (AOL) value with said location; (6) using said AOL value to target a second set of selected rows and selected columns, said second set of selected rows and selected columns optionally being a subset of said first set of selected rows and selected columns; (7) associating an exposure value with said location; (8) using said exposure value to target a third set of selected rows and selected columns, said third set of selected rows and selected columns optionally being a subset of said second set of selected rows and selected columns; (9) selecting a spatial emphasis, said spatial emphasis corresponding with one or more user preferences to either enhance or overcome inherent spatial limitations associated with said location; (10) using said spatial emphasis to target a fourth set of selected rows and selected columns, said fourth set of selected rows and selected columns optionally being a subset of said third set of selected rows and selected columns; and (11) optionally selecting one or more additional criteria, said one or more additional criteria corresponding with one or more user preferences, and using said one or more additional criteria to target one or more additional sets of selected rows and selected columns, wherein said one or more additional sets of selected rows and selected columns are a subset of one or more of the first set of selected rows and selected columns, the second set of selected rows and selected columns, the third set of selected rows and selected columns, and/or the fourth set of selected rows and selected columns.

A preferred embodiment of the invention further comprises the method wherein: (1) each of said plurality of colors is defined by a first color attribute and a second color attribute, said first color attribute being brightness, wherein brightness is light reflective value (LRV), said second color attribute being intrinsic warmth or coolness (hue), wherein said intrinsic warmth or coolness is an intrinsic “temperature” associated with said color independent of other colors; (2) said HLG is defined by an x and y axis, wherein said x axis is hue in spectrum order, and said y axis is LRV in increasing order; (3) each BCFR has a brightness value (B); and (4) each BCFR having a warmth value (W).

Further preferred embodiments comprise the preceding method wherein each BCF includes one or more secondary colors; wherein B is defined on a scale, each B corresponding to a predefined number of rows of said HLG; wherein W is defined on a scale-, each W corresponding to a predefined number of columns of said HLG; and/or wherein said functionality value is defined by a first functionality attribute and a second functionality attribute; and/or said first functionality attribute being “activity level” (AL) and said second functionality attribute being a number of persons (NP) associated with said location; and/or wherein AL is defined on a scale ranging from most active to least active, each AL corresponding to a predefined number of columns of said HLG; and/or wherein NP is defined on a scale ranging from a large number of persons to a least number of persons, each NP corresponding to a predefined number of rows of said HLG; and/or wherein said AOL value is defined on a scale ranging from least light to most light; and/or wherein said exposure value is defined on a scale including a range of values, each value being associated with a direction of exposure, said direction of exposure being selected from the group comprising north, south, east, west, northwest, northeast, southwest, and southeast; and/or wherein each value of AL on said scale of 1 to 10 is associated with a predefined number of columns of said range of selected colors (for example, the colors as selected in step (2) of claim 1)..

Further preferred embodiments comprise the preceding method including, or not including, the additional preferred features, wherein each value of NP on said scale of 1 to 10 is associated with a predefined number of rows of said range of selected colors (for example, the colors as selected in step (2) of claim 1); and/or wherein each value of AOL on said scale of 1 to 5 is associated with one or more rows of said range of selected colors (for example, the colors as selected in step (2) of claim 1).; and/or wherein each value of exposure is associated with a predefined number of columns of said range of selected colors (for example, the colors as selected in step (2) of claim 1).; and/or wherein said spatial emphasis selected (for example, the spatial emphasis as selected in step (10) of claim 1) is associated with one of four quadrants within said range of selected colors (for example, the colors as selected in step (2) of claim 1),

Another preferred embodiment of the invention comprises a method of marketing color, comprising the above methods and, one or more of the following steps: (1) applying one or more of said one or more selected colors to a location to be colored; (2) providing an executable contract, wherein said executable contract includes one or more costs and terms associated with applying one or more of said selected colors to said location; and (3) training a user to execute the method (for example, the method of claim 1).

Further preferred embodiments of the invention comprise the preceding method wherein a user is provided with one or more sample bottles, each of said sample bottles corresponding with one of said one or more selected colors; and/or wherein said method is executed electronically using a computing device; and/or wherein said HLG comprises 78 columns and 10 rows; and/or wherein said fourth set consists of six colors; and/or wherein each of said colors is a color of paint; and/or wherein each of said colors is an accent color; and/or wherein each of said colors is a color and pattern of upholstery; and/or wherein each of said colors is a color and pattern of wall covering, said wall covering being selected from the group comprising wallpaper, trim, paneling, molding, wainscoting, stenciling, and fabric.

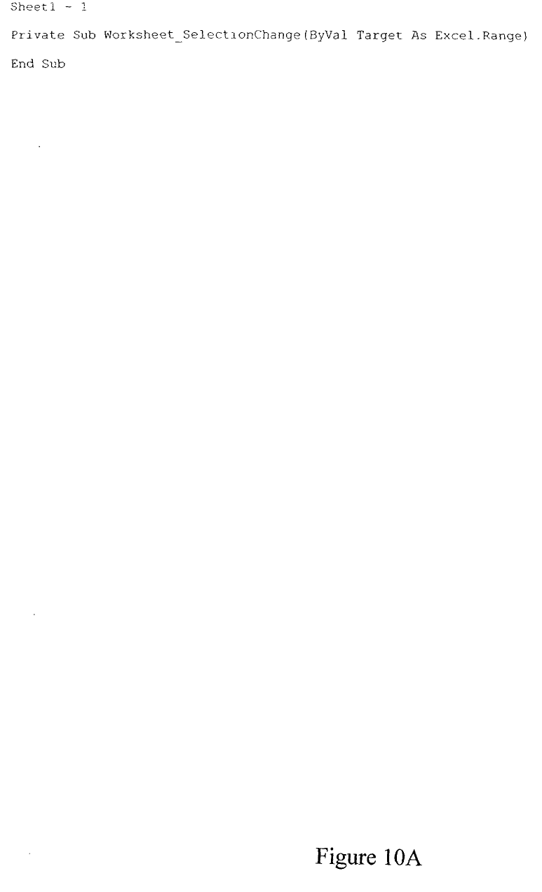

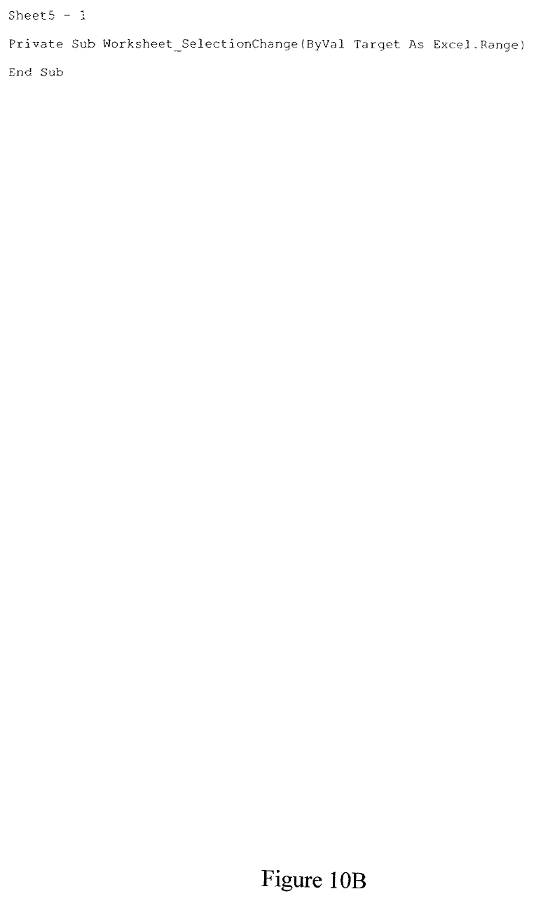

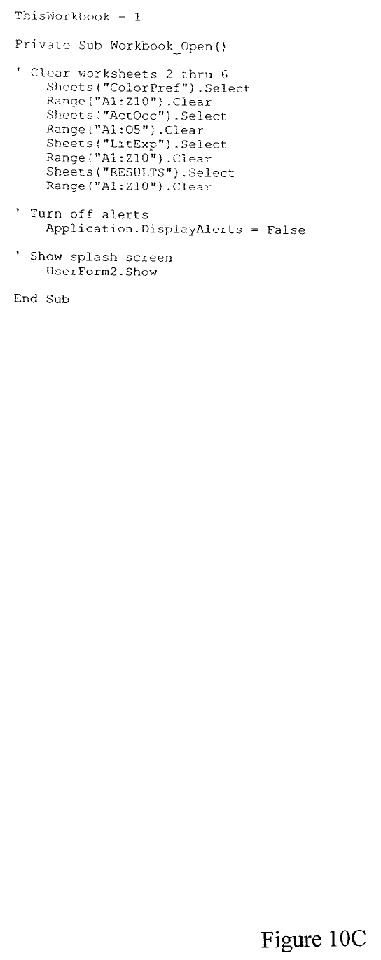

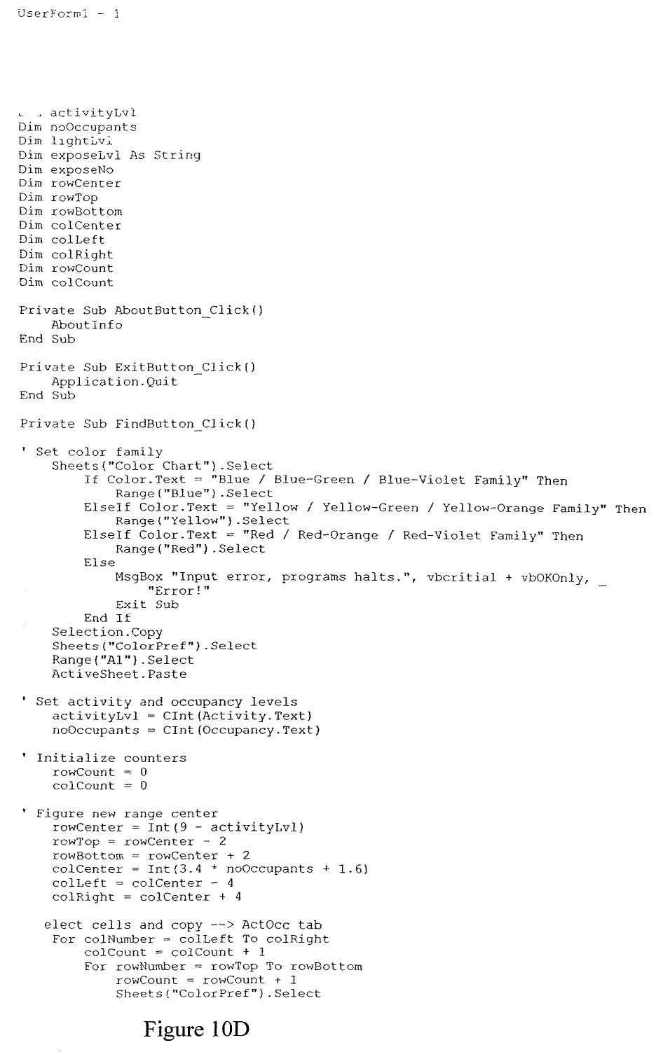

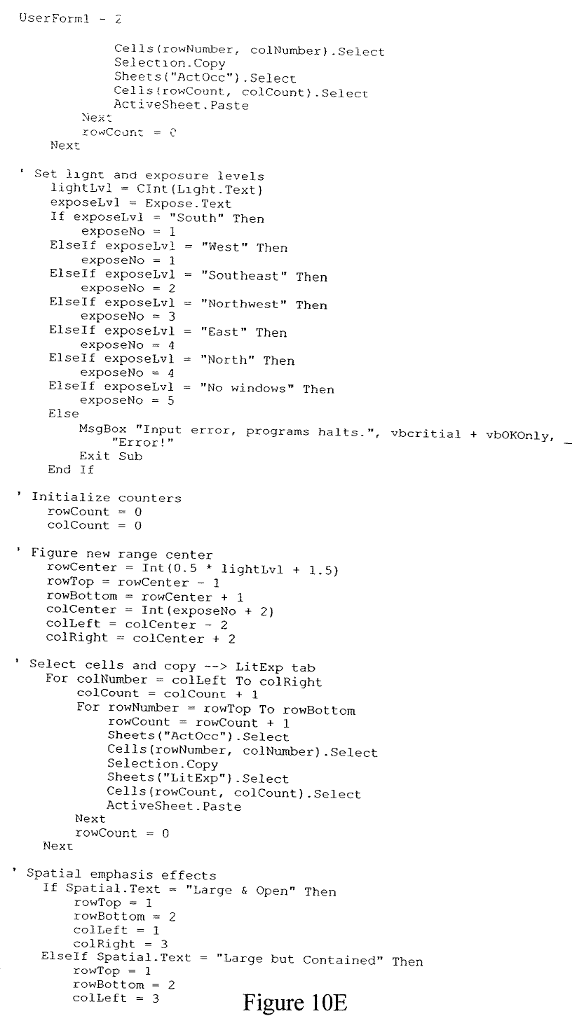

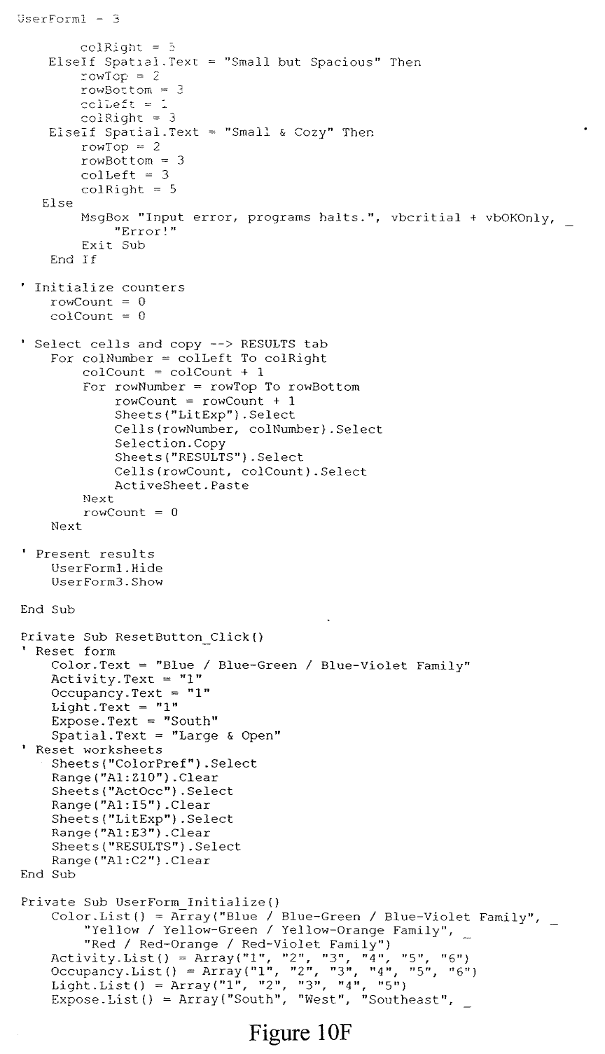

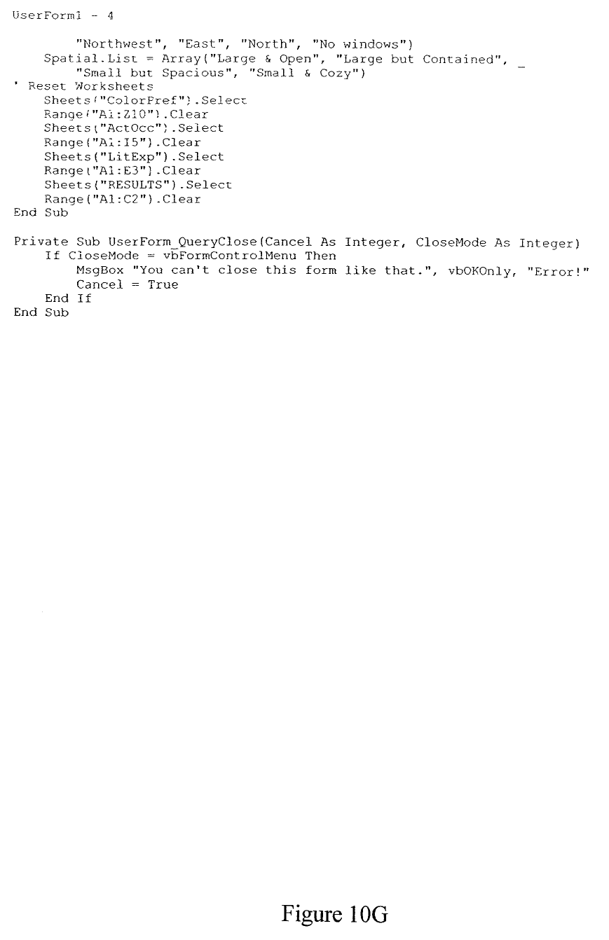

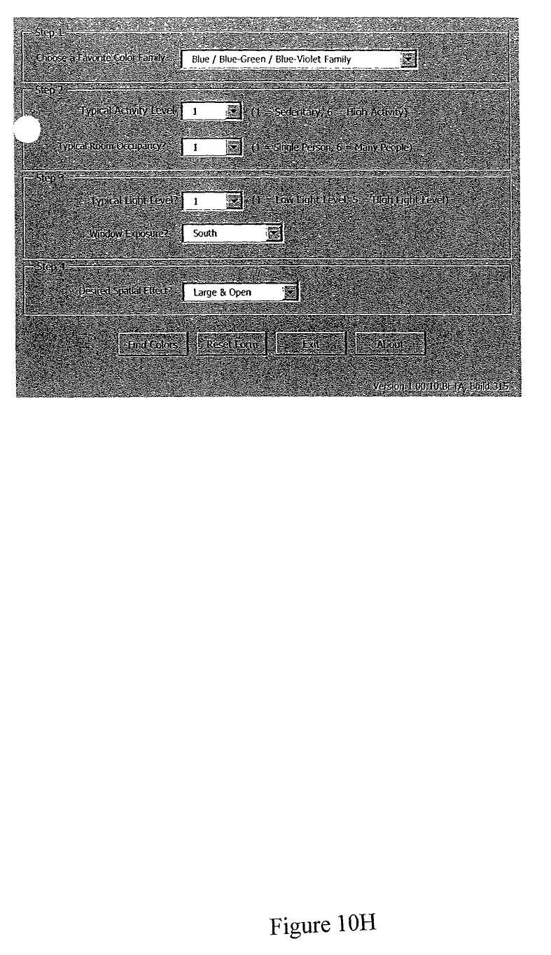

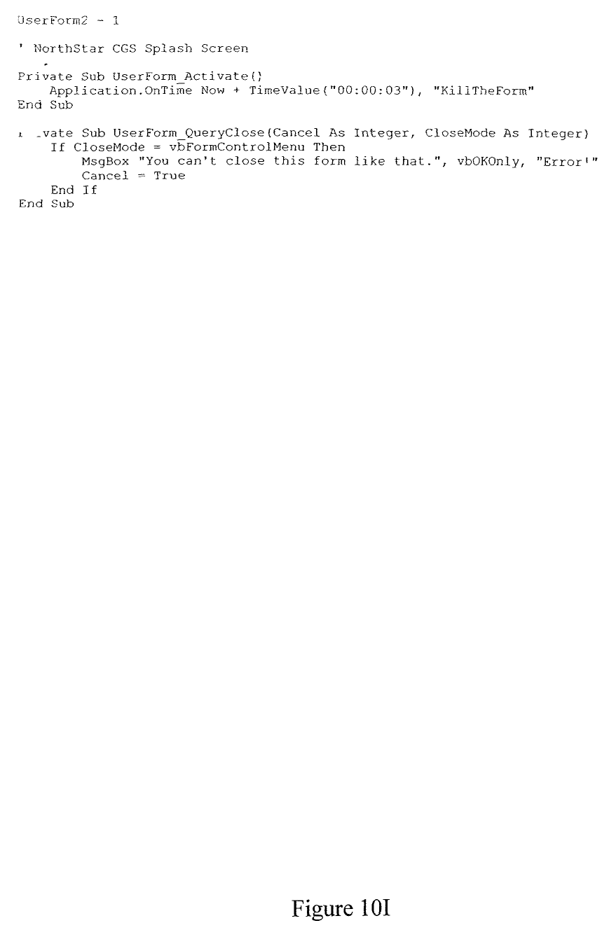

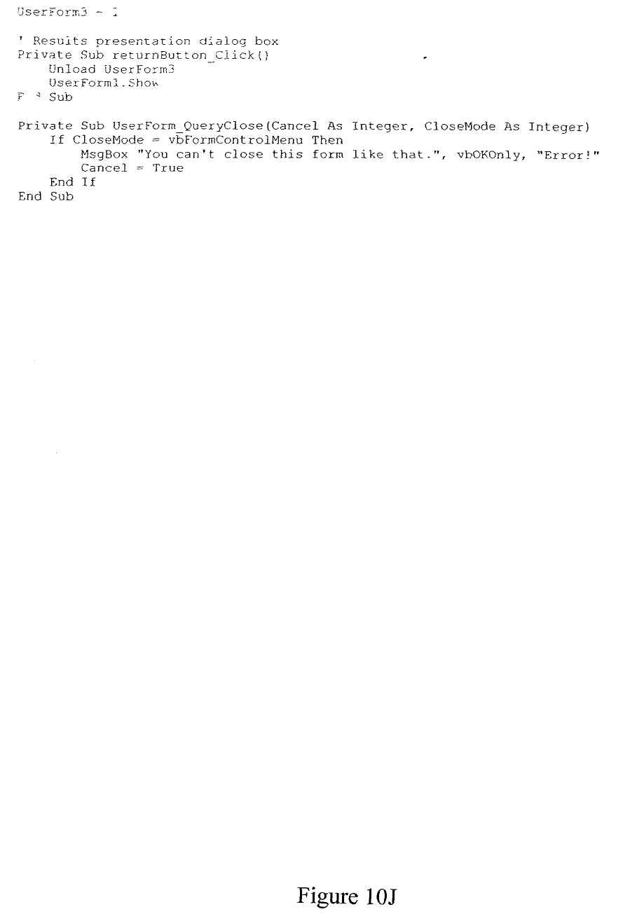

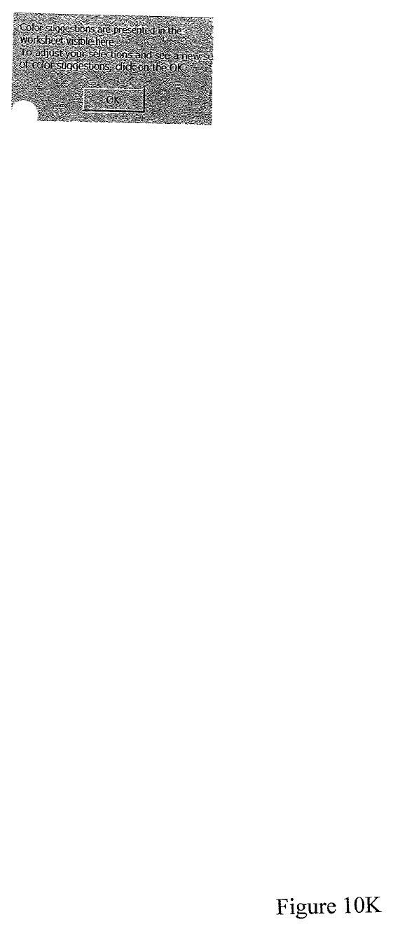

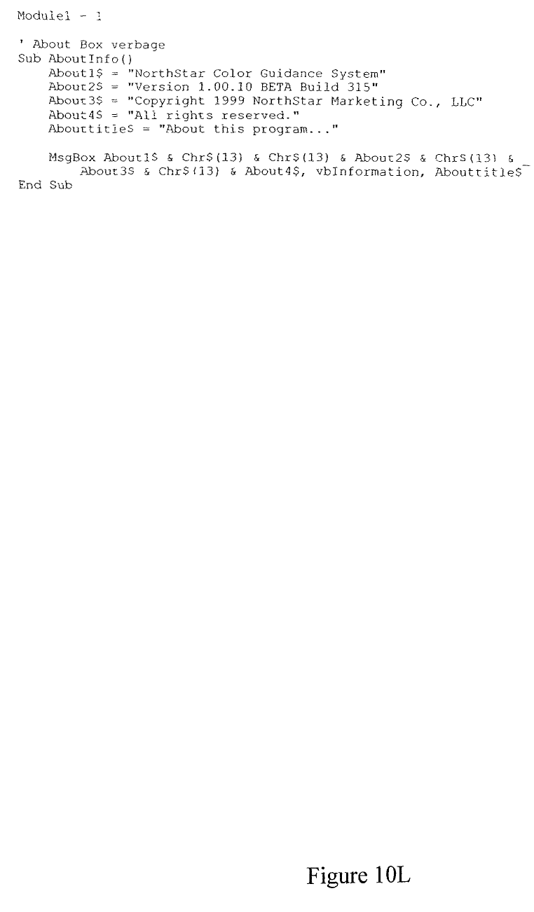

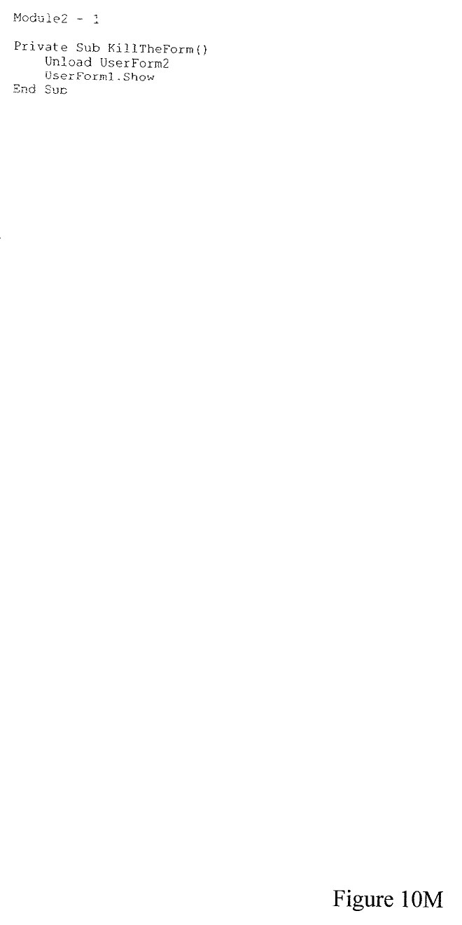

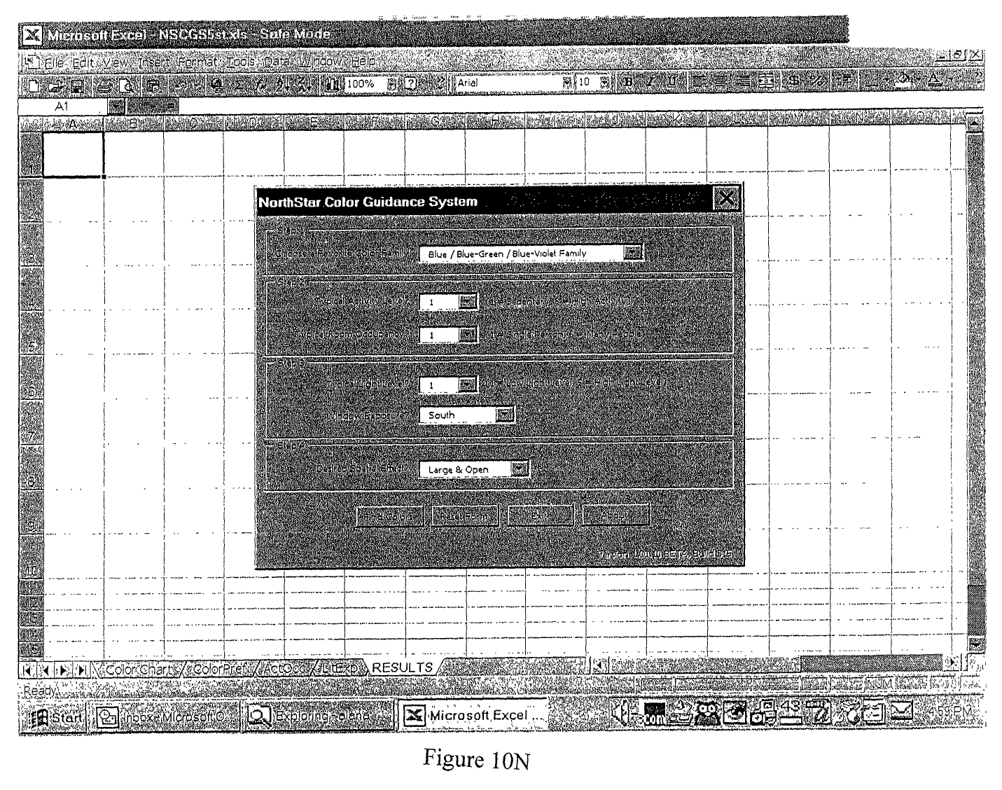

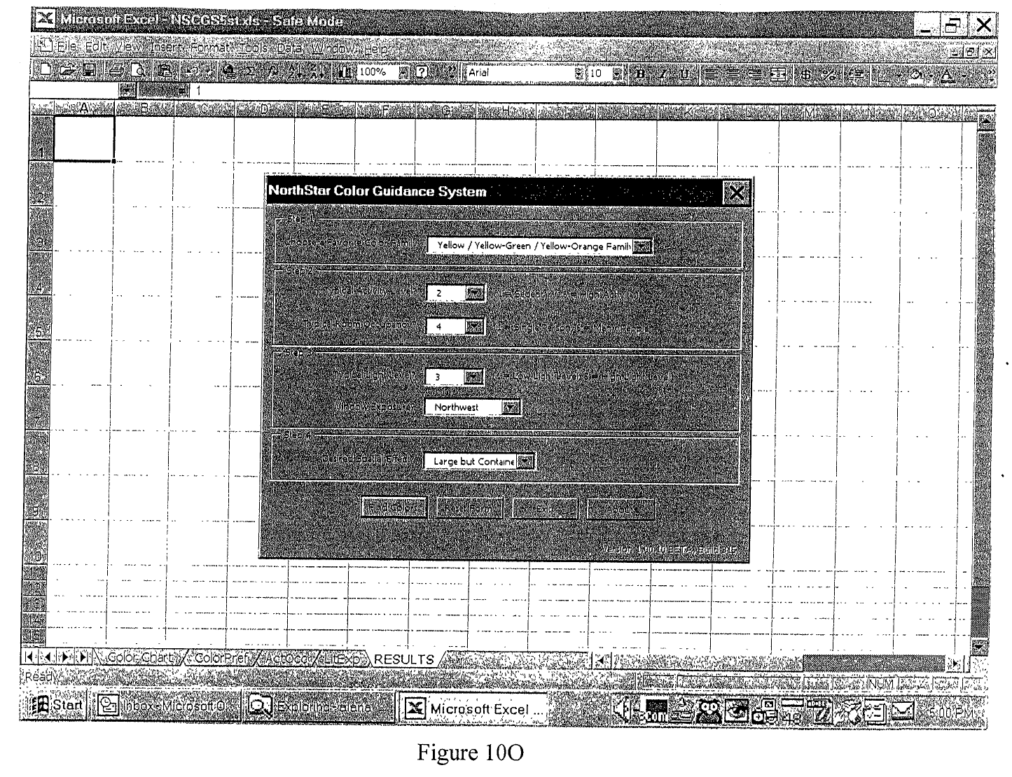

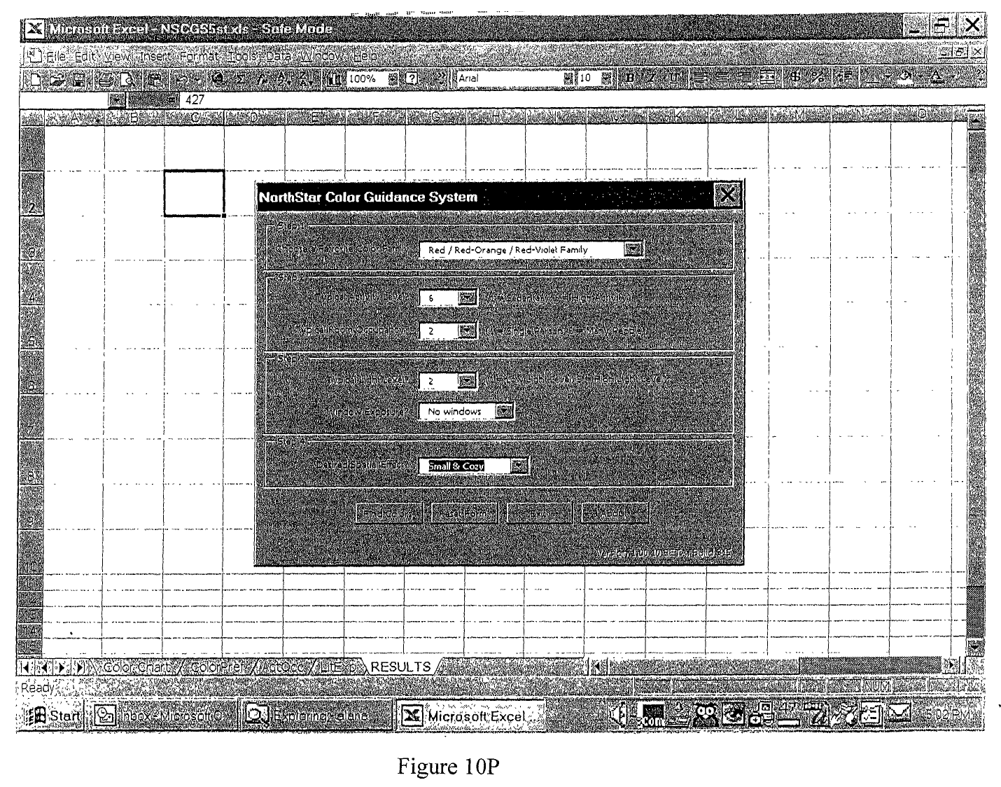

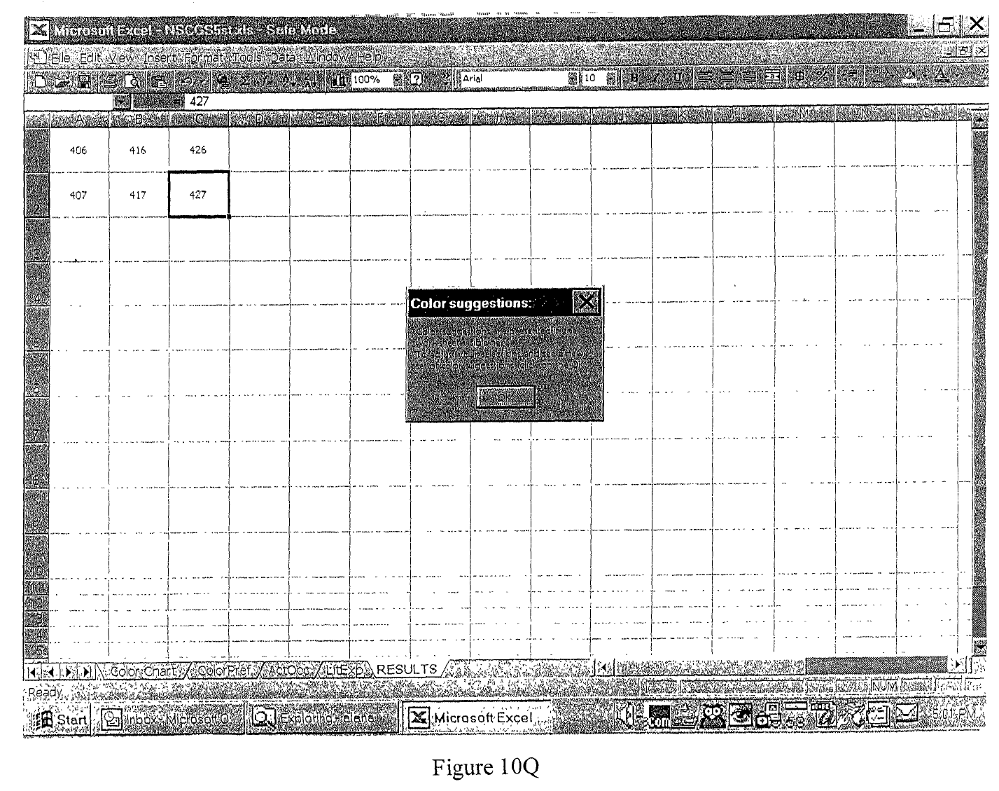

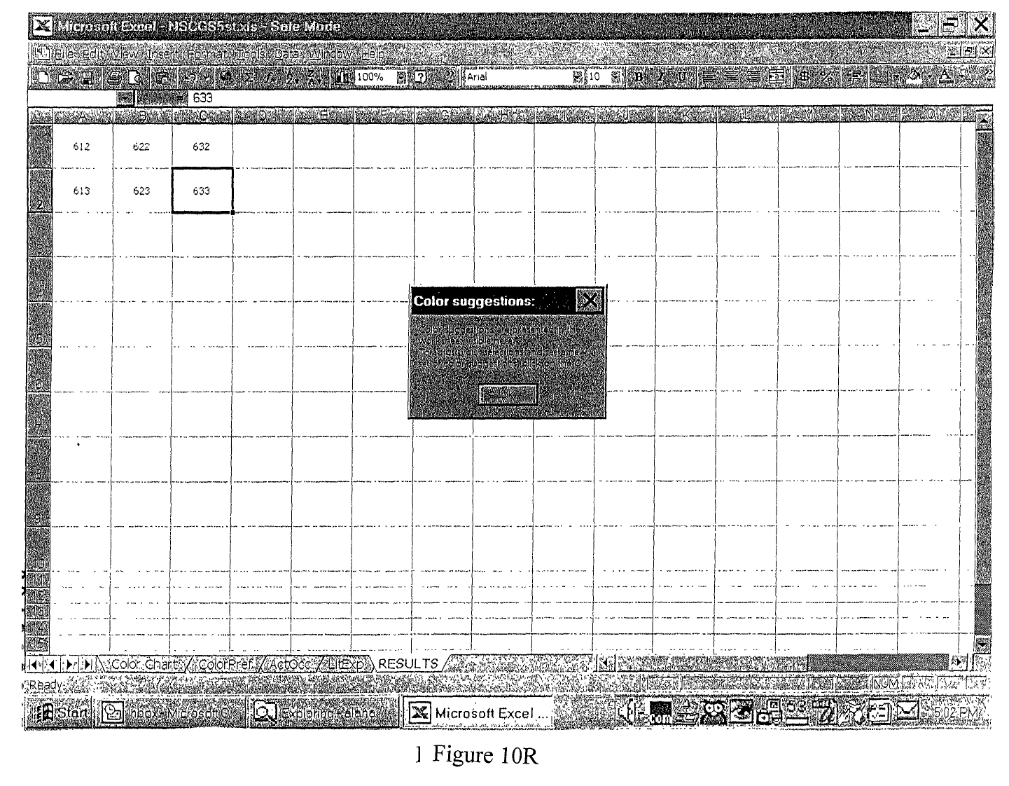

Another preferred embodiment of the invention (see FIG. 10, for example) comprises a system having a plurality of computer executable steps to implement and control a color selection system, said system comprising: (1) displaying an interface, wherein said interface provides means for displaying one or more selection criteria and for inputting user preferences; (2) storing said user preferences in a communications system; (3) using said user preferences to determine a range of colors from a “hue and light grid” (HLG), said HLG comprising a plurality of colors, wherein said HLG is divided into “basic color families” (BCF), each BCF including a primary color; (4) storing said range of colors in said communications system; (5) transmitting said range of colors to a user; (6) based on said range of colors, optionally executing one or more of the following steps: (a) applying one or more colors selected from said range of colors to a location to be colored; (b) generating an executable contract, wherein said executable contract includes one or more costs and terms associated with applying one or more of said colors to said location; (c) printing said report.

FIG. 10 presents source code enabling a preferred embodiment, such as that previously described. FIGS. 10H, 10K, 10N, 10O, 10P, 10Q and 10R depict displays of a user interface.

Further preferred embodiments of the invention comprise the preceding method wherein said interface comprises a web page downloaded by said communications system to a internet or an intranet capable of receiving one or more of said user preferences.

It is claimed:

1. A method of selecting one or more colors, said method comprising a “hue and light grid” (HLG) comprising a plurality of colors, wherein said HLG is divided into “basic color families” (BCF), each BCF including at least one primary color, and wherein each vertical row of said HLG is a “basic color family row” (BCFR), and said method comprising the following steps:
(1) selecting a location to be colored;
(2) selecting a range of colors from said HLG, said range of colors corresponding with one or more user preferences to basic colors and said range of colors being a BCF;
(3) associating a functionality value with said location;
(4) using said functionality value to target a first set of selected rows and selected columns, said first set of selected rows and selected columns being within said BCF which corresponds with said range of colors selected in step (2);
(5) associating an “amount of light” (AOL) value with said location;
(6) using said AOL value to target a second set of selected rows and selected columns, said second set of selected rows and selected columns optionally being a subset of said first set of selected rows and selected columns;
(7) associating an exposure value with said location;
(8) using said exposure value to target a third set of selected rows and selected columns, said third set of selected rows and selected columns optionally being a subset of said second set of selected rows and selected columns;
(9) selecting a spatial emphasis, said spatial emphasis corresponding with one or more user preferences to either enhance or overcome inherent spatial limitations associated with said location;
(10) using said spatial emphasis to target a fourth set of selected rows and selected columns, said fourth set of selected rows and selected columns optionally being a subset of said third set of selected rows and selected columns; and
(11) optionally selecting one or more additional criteria, said one or more additional criteria corresponding with one or more user preferences, and using said one or more additional criteria to target one or more additional sets of selected rows and selected columns, wherein said one or more additional sets of selected rows and selected columns are a subset of one or more of the first set of selected rows and selected columns, the second set of selected rows and selected columns, the third set of selected rows and selected columns, and/or the fourth set of selected rows and selected columns.

2. The method of claim 1, wherein
(1) each of said plurality of colors is defined by a first color attribute and a second color attribute, said first color attribute being brightness, wherein brightness is light reflective value (LRV), said second color attribute being intrinsic warmth or coolness (hue), wherein said intrinsic warmth or coolness is an intrinsic “temperature” associated with said color independent of other colors;
(2) said HLG is defined by an x and y axis, wherein said x axis is hue in spectrum order, and said y axis is LRV in increasing order;
(3) each BCFR has a brightness value (B); and
(4) each BCFR having a warmth value (W).

3. The methods of claims 1 and 2 wherein each BCF includes one or more secondary colors.

4. The method of claim 2 wherein B is defined on a scale, each B corresponding to a predefined number of rows of said HLG.

5. The method of claim 2 wherein W is defined on a scale-, each W corresponding to a predefined number of columns of said HLG.

6. The method of claim 2, wherein said functionality value is defined by a first functionality attribute and a second functionality attribute; said first functionality attribute being “activity level” (AL); said second functionality attribute being a number of persons (NP) associated with said location.

7. The method of claim 6 wherein AL is defined on a scale ranging from most active to least active, each AL corresponding to a predefined number of columns of said HLG.

8. The method of claim 6 wherein NP is defined on a scale ranging from a large number of persons to a least number of persons, each NP corresponding to a predefined number of rows of said HLG.

9. The method of claims 2 and 6, wherein said AOL value is defined on a scale ranging from least light to most light.

10. The method of claims 2, 6 and 9, wherein said exposure value is defined on a scale including a range of values, each value being associated with a direction of exposure, said direction of exposure being selected from the group comprising north, south, east, west, northwest, northeast, southwest, and southeast.

11. The method of claims 2, 6, 9 and 10, wherein each value of AL on said scale of 1 to 10 is associated with a predefined number of columns of said range of colors selected in step (2) of claim 1.

12. The method of claims 2, 6, 9 and 10, wherein each value of NP on said scale of 1 to 10 is associated with a predefined number of rows of said range of colors selected in step (2) of claim 1.

13. The method of claims 2, 6, 9 and 10, wherein each value of AOL on said scale of 1 to 5 is associated with one or more row s of said range of colors selected in step (2) of claim 1.

14. The method of claims 2, 6, 9 and 10, wherein each value of exposure is associated with a predefined number of columns of said range of colors selected in step (2) of claim 1.

15. The method of claims 2, 6, 9, and 10, wherein said spatial emphasis selected in step (10) of claim 1 is associated with one of four quadrants within said range of colors selected in step (2) of claim 1.

16. A method comprising the method of claims 11, 12, 13, 14, and 15.

17. A method of marketing color, comprising the method of claim 16 and, one or more of the following steps:
(1) applying one or more of said one or more selected colors to a location to be colored;
(2) providing an executable contract, wherein said executable contract includes one or more costs and terms associated with applying one or more of said selected colors to said location; and
(3) training a user to execute the method of claim 1.

18. The method of step 17, wherein a user is provided with one or more sample bottles, each of said sample bottles corresponding with one of said one or more selected colors.

19. The method of step 16, wherein said method is executed electronically using a computing device.

20. The method of step 16, wherein said HLG comprises 78 columns and 10 rows.

21. The method of step 20, wherein said fourth set consists of six colors.

22. The method of step 16, wherein each of said colors is a color of paint.

23. The method of step 16, wherein each of said colors is an accent color.

24. The method of step 16, wherein each of said colors is a color and pattern of upholstery.

25. The method of step 16, wherein each of said colors is a color and pattern of wall covering, said wall covering being selected from the group comprising wallpaper, trim, paneling, molding, wainscoting, stenciling, and fabric.

26. A system having a plurality of computer executable steps to implement and control a color selection system, said system comprising:
(1) displaying an interface, wherein said interface provides means for displaying one or more selection criteria and for inputting user preferences;
(2) storing said user preferences in a communications system;
(3) using said user preferences to determine a range of colors from a “hue and light grid” (HLG), said HLG comprising a plurality of colors, wherein said HLG is divided into “basic color families” (BCF), each BCF including a primary color;
(4) storing said range of colors in said communications system;
(5) transmitting said range of colors to a user;
(6) based on said range of colors, optionally executing one or more of the following steps:
(a) applying one or more colors selected from said range of colors to a location to be colored;
(b) generating an executable contract, wherein said executable contract includes one or more costs and terms associated with applying one or more of said colors to said location;
(c) printing said report.

27. The method of claim 26 wherein said interface comprises a web page downloaded by said communications system to a internet or an intranet capable of receiving one or more of said user preferences.
